(19) United States
(12) Patent Application Publication
(10) Pub. No.: US 2023/0325383 A1
(43) Pub. Date: Oct. 12, 2023

(54) USER INTERFACE FOR QUERY COMPOSITION AND DATA VISUALIZATION

(71) Applicant: QLIKTECH INTERNATIONAL AB, Lund (SE)

(72) Inventors: Speros Kokenes, Atlanta, GA (US); José Francisco Díaz López, Lund (SE)

(21) Appl. No.: 18/298,016

(22) Filed: Apr. 10, 2023

Related U.S. Application Data
(60) Provisional application No. 63/329,617, filed on Apr. 11, 2022.

(51) Int. Cl. G06F 16/242; G06F 16/248; G06F 9/451; G06F 3/0486; G06F 3/0482

(52) U.S. Cl. CPC G06F 16/2428; G06F 16/248; G06F 2203/04803; G06F 3/0486; G06F 3/0482; G06F 9/451

(57) ABSTRACT

Technologies are provided for composition of a query via a user interface and for visualization of data responsive to the query. For example, based on interactions with a user interface, a data model may be defined. The interactions may be drag-and-drop interactions with the user interface. Based on the data model and a data context, the query may be determined and executed.

### CROSS-REFERENCE TO RELATED PATENT APPLICATION

This application claims priority to U.S. Provisional Patent Application No. 63/329,617, which was filed on Apr. 11, 2022, and the entirety of which is incorporated by reference herein.

### SUMMARY

It is to be understood that both the following general description and the following detailed description are illustrative and explanatory only and are not restrictive.

In one embodiment, the disclosure provides a computer-implemented method. The computer-implemented method includes determining, based on a first drag-and-drop interaction with a user interface, a selection of a first element defining a data model; and determining, based on a second drag-and-drop interaction with the user interface, a selection of a second element defining a data context. The computer-implemented method also includes generating, based on the data model and the data context, a query. The computer-implemented method further includes sending the query to a computing platform configured to execute the query against a database; and receiving, from the computing platform, data responsive to the query. The computer-implemented method still further includes causing presentation of the data within a viewport pane of the user interface.

Additional elements or advantages of this disclosure will be set forth in part in the description which follows, and in part will be apparent from the description, or may be learned by practice of the subject disclosure. The advantages of the subject disclosure can be attained by means of the elements and combinations particularly pointed out in the appended claims.

This summary is not intended to identify critical or essential features of the disclosure, but merely to summarize certain features and variations thereof. Other details and features will be described in the sections that follow. Further, both the foregoing general description and the following detailed description are illustrative and explanatory only and are not restrictive of the embodiments of this disclosure.

### BRIEF DESCRIPTION OF THE DRAWINGS

The annexed drawings are an integral part of the disclosure and are incorporated into the subject specification. The drawings illustrate example embodiments of the disclosure and, in conjunction with the description and claims, serve to explain at least in part various principles, elements, or aspects of the disclosure. Embodiments of the disclosure are described more fully below with reference to the annexed drawings. However, various elements of the disclosure can be implemented in many different forms and should not be construed as limited to the implementations set forth herein. Like numbers refer to like elements throughout.

FIG. 1 is a schematic diagram showing an embodiment of a system forming an implementation of the disclosed methods, in accordance with one or more embodiments of this disclosure.

FIG. 2 is a set of tables showing exemplary Tables 1-5 of a simple database and associations between variables in the tables, in accordance with one or more embodiments of this disclosure.

FIG. 3 is a schematic flowchart showing basic operations performed when extracting information from a database, in accordance with one or more embodiments of this disclosure.

FIG. 4 illustrates an example global symbol service, in accordance with one or more embodiments of this disclosure.

FIG. 5A is a schematic diagram showing how an undetermined query operates on a scope to generate a data subset, in accordance with one or more embodiments of this disclosure.

FIG. 5B is an overview of the relations between data model, indexes in disk and windowed view of disk indexes in memory, in accordance with one or more embodiments of this disclosure.

FIG. 5C illustrates an example application of bidirectional table indexes and bidirectional association indexes, in accordance with one or more embodiments of this disclosure.

FIG. 5D is a representation of the data structure used for indexlets;

FIG. 5E illustrates an example of inter-table inferencing using indexlets, in accordance with one or more embodiments of this disclosure.

FIG. 5F illustrates an example of linking indexlets of different tables, in accordance with one or more embodiments of this disclosure.

FIG. 6 is a schematic graphical presentation showing selections and a diagram of data associated to the selections as received after processing by an external engine, in accordance with one or more embodiments of this disclosure.

FIG. 7 is a schematic representation of data exchanged with an external engine based on selections in FIG. 6, in accordance with one or more embodiments of this disclosure.

FIG. 8 is a schematic graphical presentation showing selections and a diagram of data associated to the selections as received after second computations from an external engine.

FIG. 9 is a schematic representation of data exchanged with an external engine based on selections in FIG. 8, in accordance with one or more embodiments of this disclosure.

FIG. 10 is a schematic graphical presentation showing selections and a diagram of data associated to the selections as received after third computations from an external engine, in accordance with one or more embodiments of this disclosure.

FIG. 11 is a schematic representation of data exchanged with an external engine based on selections in FIG. 10, in accordance with one or more embodiments of this disclosure.

FIG. 12 is a table showing results from computations based on different selections in the presentation of FIG. 10, in accordance with one or more embodiments of this disclosure.

FIG. 13 is a schematic graphical presentation showing a further set of selections and a diagram of data associated to the selections as received after third computations from an external engine, in accordance with one or more embodiments of this disclosure.

FIG. 14 illustrates an example of an operating environment, in accordance with one or more embodiments of this disclosure.

FIG. 15 illustrates an example of a client device, in accordance with one or more embodiments of this disclosure.

FIG. 16A illustrates examples of user interfaces and example behavior corresponding to query composition and data visualization, in accordance with one or more embodiments of this disclosure.

FIG. 16B illustrates an example of a user interface (UI), in accordance with one or more embodiments of this disclosure.

FIG. 17 schematically depicts an example of a user interface, in accordance with one or more embodiments of this disclosure.

FIG. 17A illustrates a section of the user interface schematically depicted in FIG. 17, where the section represents a configuration pane, in accordance with one or more embodiments of this disclosure.

FIG. 17B illustrates another section of the user interface schematically depicted in FIG. 17, where this other section represents a viewport pane, in accordance with one or more embodiments of this disclosure. The viewport pane includes an example of a graphical object.

FIG. 17C illustrates another section of the user interface schematically depicted in FIG. 17, where this other section represents a review pane, in accordance with one or more embodiments of this disclosure.

FIG. 17D illustrates the user interface schematically depicted in FIG. 17 and shown in parts in FIGS. 17A-17C, in accordance with one or more embodiments of this disclosure.

FIG. 17E illustrates another example of a user interface, in accordance with one or more embodiments of this disclosure.

FIG. 18A illustrates examples of viewport panes and an example of a re-size action, in accordance with one or more embodiments of this disclosure.

FIG. 18B illustrates other examples of viewport panes and another example of a re-size action, in accordance with one or more embodiments of this disclosure.

FIG. 18C illustrates other examples of viewport panes and yet another example of a re-size action, in accordance with one or more embodiments of this disclosure.

FIG. 18D illustrates other examples of viewport panes and yet another example of a re-size action, in accordance with one or more embodiments of this disclosure.

FIG. 18E illustrates other examples of viewport panes and an example of a transpose action, in accordance with one or more embodiments of this disclosure.

FIG. 19 illustrates an example of a method, in accordance with one or more embodiments of this disclosure.

FIG. 20 illustrates an example of another method, in accordance with one or more embodiments of this disclosure.

FIG. 21 illustrates an example of a computing environment that can implement query composition and data visualization, in accordance with one or more embodiments of this disclosure.

### DETAILED DESCRIPTION

The disclosure recognizes and addresses, among other technical challenges, the issue of composition of queries and visualization of data responsive to a query. Embodiments of this disclosure, include systems, devices, computer-implemented methods, and computer program products that, individually or in combination, permit generating a query using a user interface and also permit visualizing data responsive to a query. The query can be generated interactively, where by one or more selections of defined elements that define a data model and/or a data context. Interaction with the user interface can define a desired data context and/or a data model. The query can be automatically composed by including query criteria representing the data context and/or data model. The automated composition isolates the structure of a database from the construction of the query. Because such a structure defines query grammar, the isolation permits composing a query without information on the applicable query grammar. The query that is generated can be executed against the database to generate one or several data views. Visualization of a data view can dynamic, in response to the query being resolving against data identified by the data model.

Subsequent interactions with the user interface can update the data model or the data context, or both. In some cases, instead of generating an updated query, an existing query prior to the update(s) can be resolved against a different database consistent the updated data model. An updated data view can be visualized in response to the updated query being resolved.

In sharp contrast to existing technologies, the query composition and data visualization described herein decouple a client domain from a query-resolution domain, providing a straightforward and efficient mechanism for data exploration that avoids complex and difficult to maintain client-domain parsers.

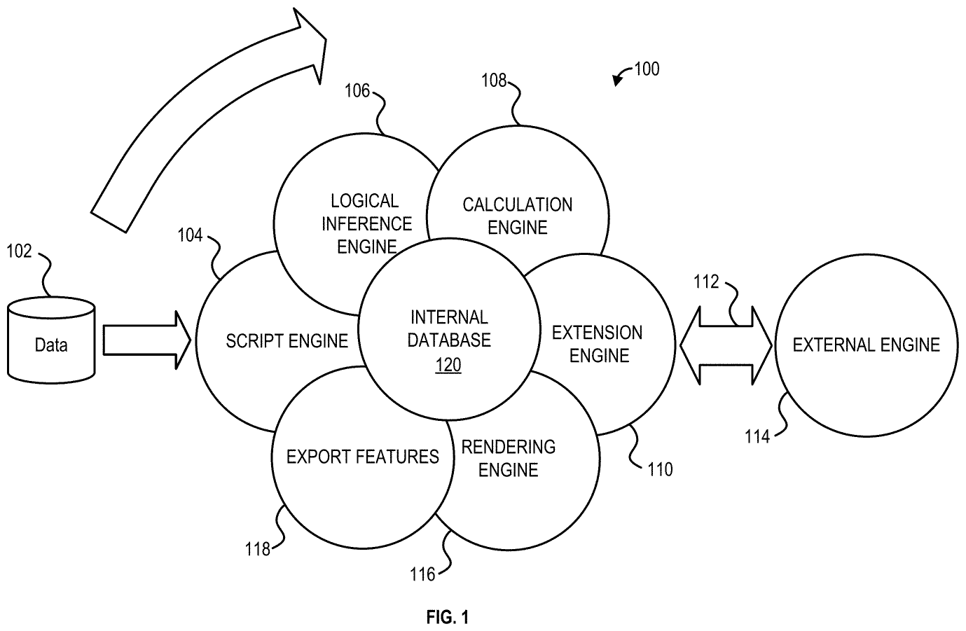

FIG. 1 shows an example associative data indexing engine 100. The associative data indexing engine 100 may determine and/or generate a response to a query. The query may be, for example, an undetermined query (e.g., an imprecise query, an undefined query, an incomplete query, a partially expressed query, a portioned query, etc.). The associative data indexing engine 100 may analyze the query based on one or more novel aggregation functions, for example, aggregation functions that are qualified to operate on a subset of data records (e.g., rather than a current selection of data records and/or a total selection of data records, etc.) and output a response. The response may be, for example, a visualization and/or one or more data analysis models (e.g., data charts, data tables, data graphs, data maps, graphical objects, key performance indicators (KPIs), etc.) that best fit aggregated data associated with the query.

FIG. 1 shows the associative data indexing engine 100 with data flowing in from the left and operations starting from a script engine 104 and going clockwise (indicated by the clockwise arrow) to export features 118. Data from a data source 102 can be extracted by a script engine 104. The data source 102 can comprise any type of known database and/or data store, such as relational databases, post-relational databases, object-oriented databases, hierarchical databases, flat files, spreadsheets, etc. The Internet may also be regarded as a database in the context of the present disclosure. A visual interface can be used as an alternative or combined with a script engine 104. The script engine 104 can read record by record from the data source 102 and data can be stored or appended to symbol and data tables in an internal database 120. Read data can be referred to as a dataset.

In an aspect, the extraction of the data can comprise extracting an initial dataset or scope from the data source 102, e.g. by reading the initial dataset into the primary memory (e.g. RAM) of a computer. The initial dataset can comprise the entire contents of the data source 102, or a subset thereof. The internal database 120 can comprise the extracted data and symbol tables. Symbol tables can be created for each field and, in one aspect, can only contain the distinct field values, each of which can be represented by their clear text meaning and a bit filled pointer. The data tables can contain said bit filled pointers.

In the case of a query of the data source 102, a scope can be defined by the tables included in a SELECT statement (or equivalent) and how these are joined. In an aspect, the SELECT statement can be SQL (Structured Query Language) based. For an Internet search, the scope can be an index of found web pages, for example, organized as one or more tables. A result of scope definition can be a dataset.

Once the data has been extracted, a user interface can be generated to facilitate dynamic display of the data. By way of example, a particular view of a particular dataset or data subset generated for a user can be referred to as a state space or a session. Embodiments of this disclosure can dynamically generate one or more visual representations of the data to present in the state space.

A user can make a selection in the dataset, causing a logical inference engine 106 to evaluate a number of filters on the dataset. For example, a query on a database that holds data of placed orders, could be requesting results matching an order year of ‘1999’ and a client group be ‘Nisse.’ The selection may thus be uniquely defined by a list of included fields and, for each field, a list of selected values or, more generally, a condition. Based on the selection, the logical inference engine 106 can generate a data subset that represents a part of the scope. The data subset may thus contain a set of relevant data records from the scope, or a list of references (e.g. indices, pointers, or binary numbers) to these relevant data records. The logical inference engine 106 can process the selection and can determine what other selections are possible based on the current selections. In an aspect, flags can enable the logical inference engine 106 to work out the possible selections. By way of example, two flags can be used: the first flag can represent whether a value is selected or not, the second can represent whether or not a value selection is possible. For every click in an application, states and colors for all field values can be calculated. These can be referred to as state vectors, which can allow for state evaluation propagation between tables.

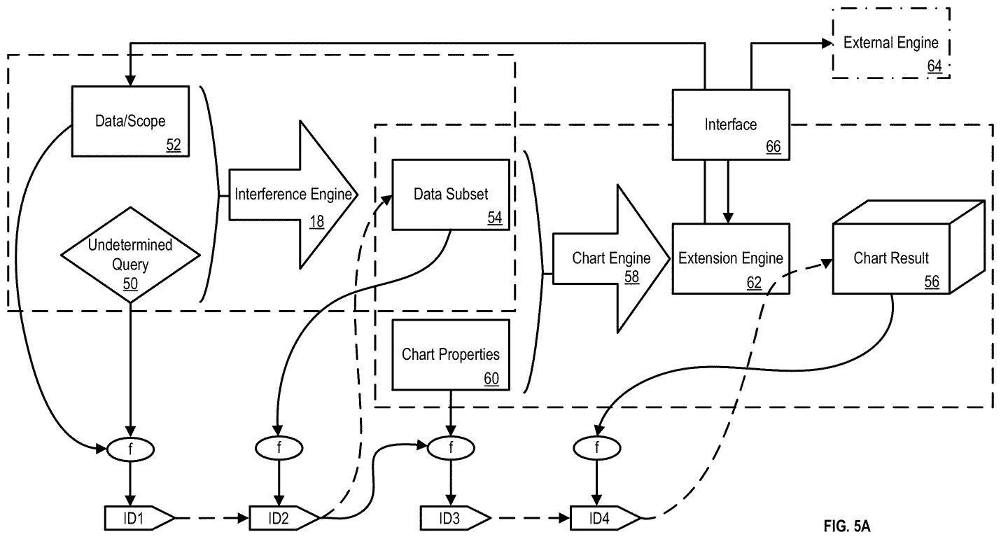

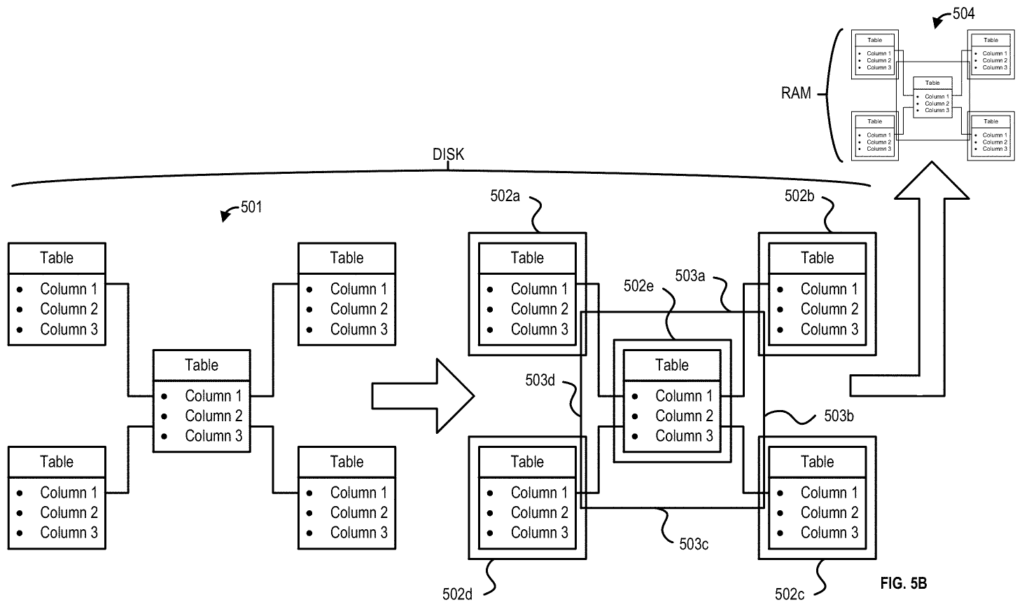

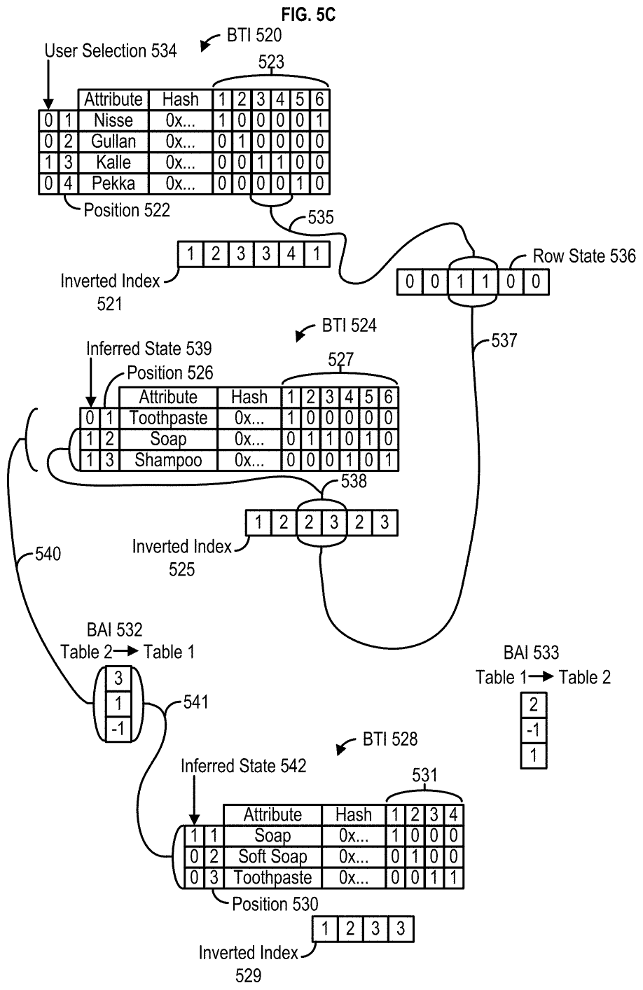

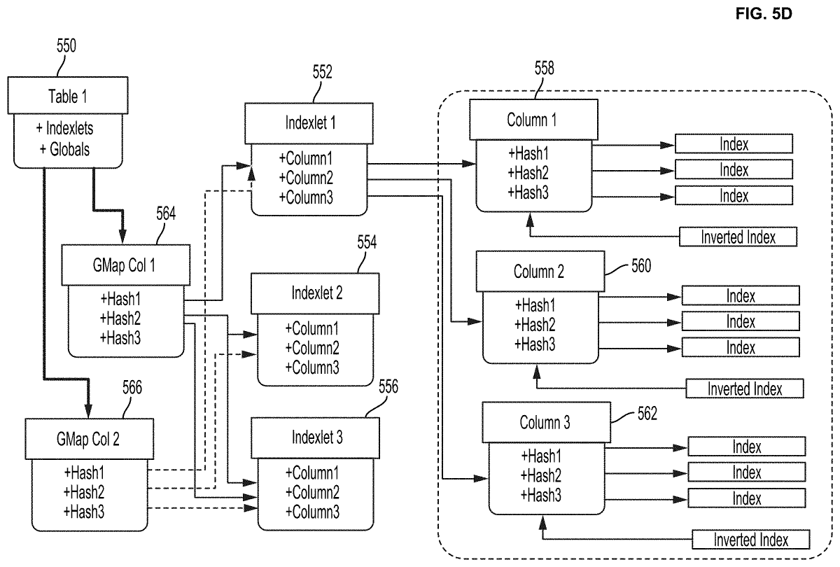

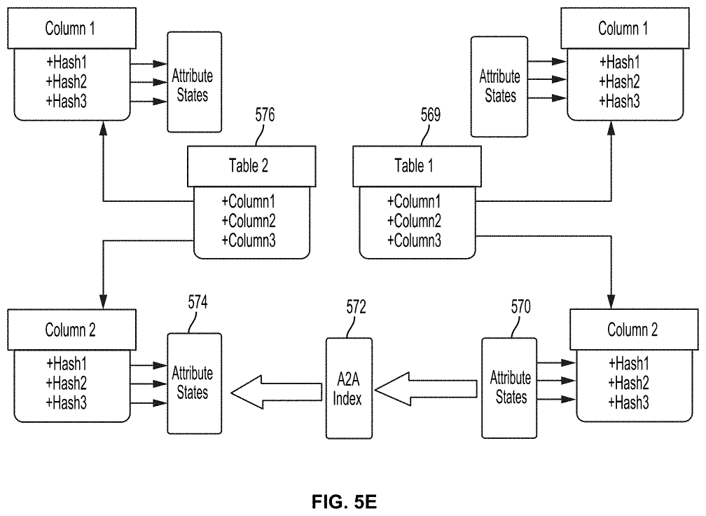

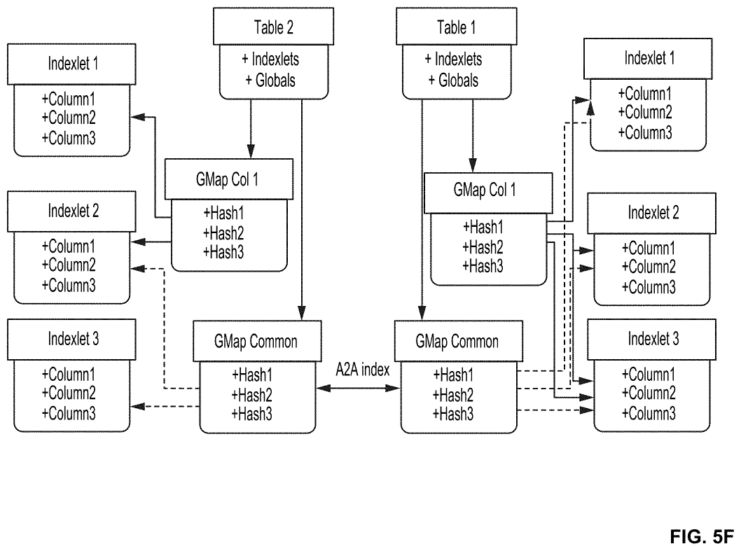

The logical inference engine 106 can utilize an associative model to connect data. In the associative model, all the fields in the data model have a logical association with every other field in the data model. An example, data model 501 is shown in FIG. 5B. The data model 501 illustrates connections between a plurality of tables that represent logical associations. Depending on the amount of data, the data model 501 can be too large to be loaded into memory. To address this issue, the logical inference engine 106 can generate one or more indexes for the data model. The one or more indexes can be loaded into memory instead of the data model 501. The one or more indexes can be used as the associative model. An index is used by database management programs to provide quick and efficient associative access to a table's records. An index is a data structure (for example, a B-tree, a hash table, and the like) that stores attributes (e.g., values) for a specific column in a table. A B-tree is a self-balancing tree data structure that keeps data sorted and allows searches, sequential access, insertions, and deletions in logarithmic time. The B-tree is a generalization of a binary search tree in that a node can have more than two children. A hash table (also referred to as a hash index) can comprise a collection of buckets organized in an array. A hash function maps index keys to corresponding buckets in the hash index.

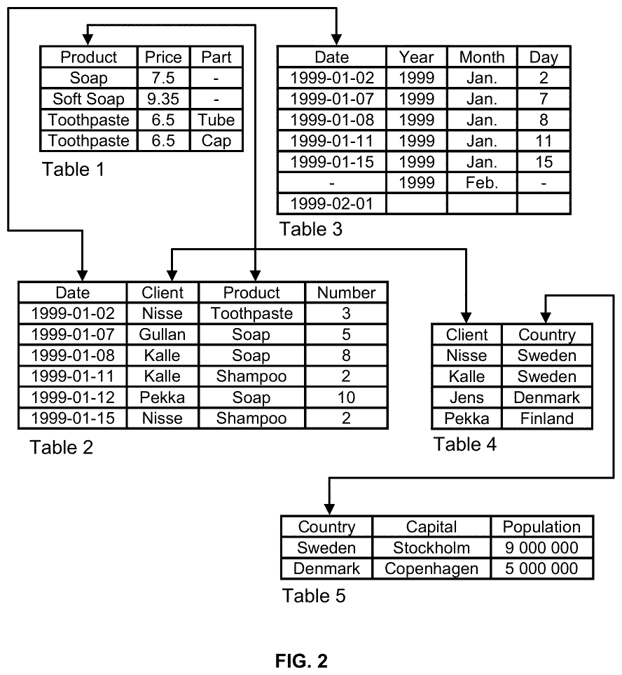

An example database, as shown in FIG. 2, can comprise a number of data tables (Tables 1-5). Each data table can contain data values of a number of data variables. For example, in Table 1 each data record contains data values of the data variables “Product,” “Price,” and “Part.” If there is no specific value in a field of the data record, this field is considered to hold a NULL-value. Similarly, in Table 2 each data record contains values of the variables “Date,” “Client,” “Product,” and “Number.” In Table 3 each data record contains values of variable “Date” as “Year,” “Month” and “Day.” In Table 4 each data record contains values of variables “Client” and “Country,” and in Table 5 each data record contains values of variables “Country,” “Capital,” and “Population.” Typically, the data values are stored in the form of ASCII-coded strings, but can be stored in any form.

Queries that compare for equality to a string can retrieve values very fast using a hash index. For instance, referring to the tables of FIG. 2, a query of SELECT*FROM Table 2 WHERE Client=‘Kalle’ could benefit from a hash index created on the Client column. In this example, the hash index would be configured such that the column value will be the key into the hash index and the actual value mapped to that key would just be a pointer to the row data in Table 2. Since a hash index is an associative array, a typical entry can comprise “Kalle=>0x29838”, where 0x29838 is a reference to the table row where Kalle is stored in memory. Thus, looking up a value of “Kalle” in a hash index can return a reference to the row in memory which is faster than scanning Table 2 to find all rows with a value of “Kalle” in the Client column. The pointer to the row data enables retrieval of other values in the row.

As shown in FIG. 5B, the logical inference engine 106 can be configured for generating one or more bidirectional table indexes (BTI) 502a, 502b, 502c, 502d, and/or 502e and one or more bidirectional associative indexes (BAI) 503a, 503b, 503c and/or 503d based on a data model 501. The logical inference engine 106 can scan each table in the data model 501 and create the BTI 502a, 502b, 502c, 502d, and/or 502e. A BTI can be created for each column of each table in the data. The BTI 502a, 502b, 502c, 502d, and/or 502e can comprise a hash index. The BTI 502a, 502b, 502c, 502d, and/or 502e can comprise first attributes and pointers to the table rows comprising the first attributes. For example, referring to the tables of FIG. 2, an example BTI 502a can comprise “Kalle=>0x29838”, where Kalle is an attribute found in Table 2 and 0x29838 is a reference to the row in Table 2 where Kalle is stored in memory. Thus, the BTI 502a, 502b, 502c, 502d, and/or 502e can be used to determine other attributes in other columns (e.g., second attributes, third attributes, etc.) in table rows comprising the first attributes. Accordingly, the BTI can be used to determine that an association exists between the first attributes and the other attributes.

The logical inference engine 106 can scan one or more of BTI 502a, 502b, 502c, 502d, and/or 502e and create the BAI 503a, 503b, 503c and/or 503d. The BAI 503a, 503b, 503c, and/or 503d can comprise a hash index. The BAI 503a, 503b, 503c, and/or 503d can comprise an index configured for connecting attributes in a first table to common columns in a second table. The BAI 503a, 503b, 503c, and/or 503d thus allows for identification of rows in the second table which then permits identification of other attributes in other tables. For example, referring to the tables of FIG. 2, an example BAI 503a can comprise “Kalle=>0x39838”, where Kalle is an attribute found in Table 2 and 0x39838 is a reference to a row in Table 4 that contains Kalle. In an aspect, the reference can be to a hash that can be in-memory or on disk.

Using the BTI 502a, 502b, 502c, 502d, and/or 502e and the BAI 503a, 503b, 503c, and/or 503d, the logical inference engine 106 can generate an index window 504 by taking a portion of the data model 501 and mapping it into memory. The portion of the data model 501 taken into memory can be sequential (e.g., not random). The result is a significant reduction in the size of data required to be loaded into memory.

In an aspect, bidirectional indexing using BTIs can have limits as to how much parallelization can be applied when processing the data model 501. To improve parallelization applied to the data model 501, the logical inference engine 106 can generate bidirectional indexes for partitions for a table in the data model 501. Such bidirectional indexes are hereinafter referred to as “indexlets.” In an aspect, the logical inference engine 106 can generate indexlets for a given table by partitioning the table into blocks of rows. In an aspect, the blocks of rows can be of a same size. In an aspect, a last block of rows can be of a size less than the remaining blocks of rows. In an aspect, after partitioning the blocks of rows, the logical inference engine can generate an indexlet for each of the blocks of rows. In an aspect, generating an indexlet for a given block of rows comprises generating a bidirectional index as described above, but limited in scope to the given block of rows.

Provided the input data sources, the logical inference engine 106 can implement an indexation process (e.g., symbol indexation) to generates the indexlets. Indexlets thus generated can serve as a foundation for providing bi-directional indexing information for the both inferencing and/or hypercube domain calculation techniques.

Given an input data source 102 in an interpretable format, e.g., comma-separated values (CSV) format, the indexation process can begin with partitioning the data source 102 into disjoint, same-sized blocks of rows. In some aspects, the indexation process will not partition the last row (e.g., the size of the last block might be smaller than the size of the other blocks). These “slices” of the data can be then processed independently to generate intermediate indexlet structures. Intermediate indexlet structures can be processed sequentially to generate a global symbol map. In addition to bi-directional information (symbol to row and row to symbol), a mapping between the symbols can reside locally in the indexlet and in the global symbol map. This mapping enables a simple yet fast and efficient transformation between symbols in an indexlet and in global symbol maps and vice versa through select and rank operations on bit vectors.

There are two main challenges to the indexation process: parallelization of the creation of intermediate indexlet structures and the creation and handling of large global symbol maps that contain potentially billions of symbols.

The indexation process can be divided into two components: an indexer service and a global symbol service. While the indexer service handles an indexation request as well as distributing tasks of creating the intermediate indexlet structures, the global symbol service enables splitting global symbol maps across machines. Even in good hash map implementations, there is always overhead in memory consumption due to the management of the internal data structure. As result, the ability to split global symbol maps across machines helps to share the load as well as supporting both horizontal and vertical scaling when dealing with large dataset.

To achieve the maximum parallelization of the creation of intermediate indexlet structures, the indexer service can utilize a distributed computing environment. A master node can comprise information regarding the capability of worker nodes registered during their initialization. On receiving an indexation request, the master node distributes tasks to worker nodes based on the registered capability. In this setup, more worker nodes can be dynamically added and registered with the master node to reduce the required creation time of the intermediate indexlet structures. Moreover, if a worker node dies during the process, a new worker node can be instantiated and registered to the master node to take over the corresponding tasks. The master node can also communicate with a global symbol master node to get global symbol maps initialized and ready for the global symbol service.

When dealing with large datasets, global symbol maps can comprise billions of symbols. Naturally, an in-memory hash map can provide better performance on both look up and insert operations in comparison to file-based hash map implementations. Unfortunately, it is not practical to have an unlimited amount of physical memory available. Although virtual memory can help to elevate the limitation of physical memory, the performance of lookup and insert operations degrades dramatically.

A global symbol service is provided in which global symbol maps are split across machines to share the load as well as the stress on memory requirements while achieving the desired performance.

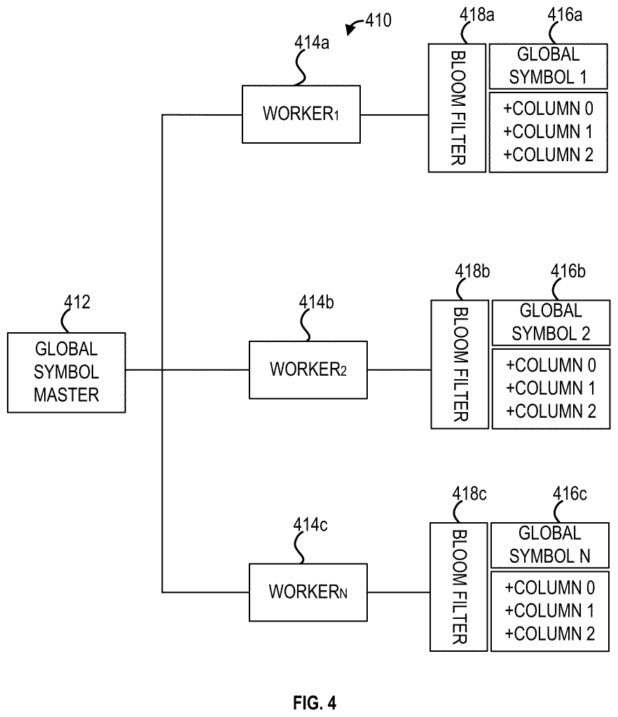

FIG. 4 illustrates a global symbol service 410. During an initialization process, worker nodes 414a, 414b, and 414c register their capabilities, e.g., amount of memory, processing power, bandwidth, etc., with a global master node 412. On receiving an indexation request, for example from the indexer master node 402, the global symbol master node 412 can request initialization of global symbol maps 416a, 416b, and 416c on worker nodes 414a, 414b, and 414c based on the registered capabilities. As a result, the global symbol maps 416a, 416b, and 416c are initialized, and proper capability is reserved accordingly.

The indexer service and the global symbol service can generate intermediate indexlet structures and process the intermediate indexlet structures sequentially to generate the global symbol maps together with bi-directional indexing information. This constraint on processing order permits fast and efficient mappings between symbols that reside locally in an indexlet and the global symbol maps. The global symbol service allows parallelism to improve indexation performance.

For example, a state, S, can be introduced into the global symbol maps 416a, 416b, and 416c on the worker nodes 414a, 414b, and 414c as follows

S={standing_by,serving,closed}
where “standing_by” indicates that the global symbol map on the worker node is not in use, “serving” indicates that the global symbol map on the worker node can be used for both lookup and insert operations, “closed” indicates that the global symbol map on the worker node is full, and, thus, only supports a lookup operation.

The creation of the global symbol map can start with inserting symbols into a serving hash map on the corresponding worker node. When the optimal capacity of the hash map is reached, the corresponding worker node informs the global symbol master node and changes its state to closed. The global symbol master node can then request another worker node to handle the upcoming tasks, e.g., changing the state of a hash map from “standing_by” to “serving.” On subsequent processes, lookup operations can be carried out in a bulk and in a parallelized manner on a closed hash map to maximize the performance. The remaining new symbols can then be inserted into the serving hash map on the corresponding worker node. If a worker node in “standing_by” state dies during the process, it can be replaced by instantiating another worker node that registers itself to the master node. If a worker node in “closed” or “serving” state dies, it can be replaced by either another worker node in “standing_by” state or a newly instantiated worker node. In this case, the master node informs the indexer service and the range of the corresponding data will be indexed again to reconstruct the corresponding hash map.

In an aspect, a Bloom filter 418a, 418b, and 418c can be used to further optimize lookup performance. A Bloom filter is a probabilistic data structure that can indicate whether an element either definitely is not in the set or may be in the set. In other words, false-positive matches are possible, but false negatives are not. The base data structure of a Bloom filter is a bit vector. On a very large hash map that contains several billion symbols, the performance of the lookup operation can degrade dramatically as the size increases. The Bloom filter is a compact data structure that can represent a set with an arbitrarily large number of elements. The Bloom filter enables fast querying of the existence of an element in a set. Depending on the registered resource information, the false positive rate can be specified to achieve both the compactness of the Bloom filter and the minimum access to the hash map. A Bloom filter can improve the performance of lookup operation on closed hash map by 3 to 5 times. The constructed Bloom filter 418a, 418b, and 418c can be used to minimize the amount of communication required in the inferencing as well as hypercube domain construction process. Particularly, by performing lookup operations in the Bloom filters 418a, 418b, and 418c first, the number of hash maps that possibly contain the desired information will be minimized, and, thus, reduce the number of requests that need to be transferred through the network

The indexer service and the global symbol service allows both local as well as cloud-based deployment of symbol indexation. With the cloud-based deployment, more resources can be added to improve the indexation process. The indexation process is bounded by the amount of resources and the available bandwidth. In large-scale deployment, direct communication between indexer worker nodes 404a, 404b, and 404c and global symbol worker nodes 414a, 414b, and 414c can be setup to reduce the load on the global symbol master node 412.

A representation of a data structure for indexlets is shown in FIG. 5D. Rows of a given table 550 can be divided into block bidirectionally indexed by indexlets 552, 554, and 556, respectively. In the example of FIG. 5D, the indexlet 552 can include pointers or references to respective columns 558, 560, and 562 as set forth above with respect to bidirectional table indexes. Each of the indexlets 552, 554, and 556 are logically associated with a bidirectional global attribute lists 564 and 566 that index a particular attribute to the blocks it is present in. Accordingly, an entry in the bidirectional global attribute list 564 and 566 for a given attribute can comprise a reference to an indexlet corresponding to a block having the respective attribute. In an aspect, the reference can include a hash reference. In an aspect, as shown in FIG. 5F, an implicit relationship exists between indexlets in different tables through a common field present in both tables and an attribute-to-attribute (A2A) index.

Thus, the logical inference engine 106 can determine a data subset based on user selections. The logical inference engine 106 automatically maintains associations among every piece of data in the entire dataset used in an application. The logical inference engine 106 can store the binary state of every field and of every data table dependent on user selection (e.g., included or excluded). This can be referred to as a state space and can be updated by the logical inference engine 106 every time a selection is made. There is one bit in the state space for every value in the symbol table or row in the data table, as such the state space is smaller than the data itself and faster to query. The inference engine will work associating values or binary symbols into the dimension tuples. Dimension tuples are normally needed by a hypercube to produce a result.

The associations thus created by the logical inference engine 106 means that when a user makes a selection, the logical inference engine 106 can resolve (quickly) which values are still valid (e.g., possible values) and which values are excluded. The user can continue to make selections, clear selections, and make new selections, and the logical inference engine 106 will continue to present the correct results from the logical inference of those selections. In contrast to a traditional join model database, the associative model provides an interactive associative experience to the user.

FIG. 5C illustrates an example application of BTIs and BAIs to determine inferred states both inter-table and intra-table using Table 1 and Table 2 of FIG. 2. A BTI 520 can be generated for the “Client” attribute of Table 2. In an aspect, the BTI 520 can comprise an inverted index 521. In other aspect, the inverted index 521 can be considered a separate structure. The BTI 520 can comprise a row for each unique attribute in the “Client” column of Table 2. Each unique attribute can be assigned a corresponding position 522 in the BTI 520. In an aspect, the BTI 520 can comprise a hash for each unique attribute. The BTI 520 can comprise a column 523 for each row of Table 2. For each attribute, a “1” can indicate the presence of the attribute in the row and a “0” can indicate an absence of the attribute from the row. “0” and “1” are merely examples of values used to indicate presence or absence. Thus, the BTI 520 reflects that the attribute “Nisse” is found in rows 1 and 6 of Table 2, the attribute “Gullan” is found in row 2 of Table 2, the attribute “Kalle” is found in rows 3 and 4 of Table 2, and the attribute “Pekka” is found in row 5 of Table 2.

The inverted index 521 can be generated such that each position in the inverted index 521 corresponds to a row of Table 2 (e.g., first position corresponds to row 1, second position corresponds to row 2, etc. . . . ). A value can be entered into each position that reflects the corresponding position 522 for each attribute. Thus, in the inverted index 521, position 1 comprises the value “1” which is the corresponding position 522 value for the attribute “Nisse”, position 2 comprises the value “2” which is the corresponding position 522 value for the attribute “Gullan”, position 3 comprises the value “3” which is the corresponding position 522 value for the attribute “Kalle”, position 4 comprises the value “3” which is the corresponding position 522 value for the attribute “Kalle”, position 5 comprises the value “4” which is the corresponding position 522 value for the attribute “Pekka”, and position 6 comprises the value “1” which is the corresponding position 522 value for the attribute “Nisse”.

A BTI 524 can be generated for the “Product” attribute of Table 2. In an aspect, the BTI 524 can comprise an inverted index 525. In other aspect, the inverted index 525 can be considered a separate structure. The BTI 524 can comprise a row for each unique attribute in the “Product” column of Table 2. Each unique attribute can be assigned a corresponding position 526 in the BTI 524. In an aspect, the BTI 524 can comprise a hash for each unique attribute. The BTI 524 can comprise a column 527 for each row of Table 2. For each attribute, a “1” can indicate the presence of the attribute in the row and a “0” can indicate an absence of the attribute from the row. “0” and “1” are merely examples of values used to indicate presence or absence. Thus, the BTI 524 reflects that the attribute “Toothpaste” is found in row 1 of Table 2, the attribute “Soap” is found in rows 2, 3, and 5 of Table 2, and the attribute “Shampoo” is found in rows 4 and 6 of Table 2.

By way of example, the inverted index 525 can be generated such that each position in the inverted index 525 corresponds to a row of Table 2 (e.g., first position corresponds to row 1, second position corresponds to row 2, etc.). A value can be entered into each position that reflects the corresponding position 526 for each attribute. Thus, in the inverted index 525, position 1 comprises the value “1” which is the corresponding position 526 value for the attribute “Toothpaste”, position 2 comprises the value “2” which is the corresponding position 526 value for the attribute “Soap”, position 3 comprises the value “2” which is the corresponding position 526 value for the attribute “Soap”, position 4 comprises the value “3” which is the corresponding position 526 value for the attribute “Shampoo”, position 5 comprises the value “2” which is the corresponding position 526 value for the attribute “Soap”, and position 6 comprises the value “3” which is the corresponding position 526 value for the attribute “Shampoo.”

By way of example, a BTI 528 can be generated for the “Product” attribute of Table 1. In an aspect, the BTI 528 can comprise an inverted index 529. In other aspect, the inverted index 529 can be considered a separate structure. The BTI 528 can comprise a row for each unique attribute in the “Product” column of Table 1. Each unique attribute can be assigned a corresponding position 530 in the BTI 528. In an aspect, the BTI 528 can comprise a hash for each unique attribute. The BTI 528 can comprise a column 531 for each row of Table 1. For each attribute, a “1” can indicate the presence of the attribute in the row and a “0” can indicate an absence of the attribute from the row. “0” and “1” are merely examples of values used to indicate presence or absence. Thus, the BTI 528 reflects that the attribute “Soap” is found in row 1 of Table 1, the attribute “Soft Soap” is found in row 2 of Table 1, and the attribute “Toothpaste” is found in rows 3 and 4 of Table 1.

By way of example, the inverted index 529 can be generated such that each position in the inverted index 529 corresponds to a row of Table 1 (e.g., first position corresponds to row 1, second position corresponds to row 2, etc. . . . ). A value can be entered into each position that reflects the corresponding position 530 for each attribute. Thus, in the inverted index 529, position 1 comprises the value “1” which is the corresponding position 530 value for the attribute “Soap”, position 2 comprises the value “2” which is the corresponding position 530 value for the attribute “Soft Soap”, position 3 comprises the value “3” which is the corresponding position 530 value for the attribute “Toothpaste”, and position 4 comprises the value “3” which is the corresponding position 530 value for the attribute “Toothpaste”.

By way of example, a BAI 532 can be generated as an index between the product attribute of Table 2 and Table 1. The BAI 532 can comprise a row for each unique attribute in the BTI 524 by order of corresponding position 526. The value in each row can comprise the corresponding position 530 of the BTI 528. Thus, position 1 of the BAI 532 corresponds to “Toothpaste” in the BTI 524 (corresponding position 526 of 1) and comprises the value “3” which is the corresponding position 530 for “Toothpaste” of the BTI 528. Position 2 of the BAI 532 corresponds to “Soap” in the BTI 524 (corresponding position 526 of 2) and comprises the value “1” which is the corresponding position 530 for “Soap” of the BTI 528. Position 3 of the BAI 532 corresponds to “Shampoo” in the BTI 524 (corresponding position 526 of 3) and comprises the value “−1” which indicates that the attribute “Shampoo” is not found in Table 1.

By way of example, a BAI 533 can be created to create an index between the product attribute of Table 1 and Table 2. The BAI 533 can comprise a row for each unique attribute in the BTI 528 by order of corresponding position 530. The value in each row can comprise the corresponding position 526 of the BTI 524. Thus, position 1 of the BAI 533 corresponds to “Soap” in the BTI 528 (corresponding position 530 of 1) and comprises the value “2” which is the corresponding position 526 for “Soap” of the BTI 524. Position 2 of the BAI 533 corresponds to “Soft Soap” in the BTI 528 (corresponding position 530 of 2) and comprises the value “−1” which indicates that the attribute “Soft Soap” is not found in Table 2. Position 3 of the BAI 533 corresponds to “Toothpaste” in the BTI 528 (corresponding position 530 of 3) and comprises the value “1” which is the corresponding position 526 for “Toothpaste” of the BTI 524.

FIG. 5C illustrates an example application of the logical inference engine 106 utilizing the BTI 520, the BTI 524, and the BTI 528. A user can select the “Client” “Kalle” from within a user interface. A column for a user selection 534 of “Kalle” can be indicated in the BTI 520 comprising a value for each attribute that reflects the selection status of the attribute. Thus, the user selection 534 comprises a value of “0” for the attribute “Nisse” indicating that “Nisse” is not selected, the user selection 534 comprises a value of “0” for the attribute “Gullan” indicating that “Gullan” is not selected, the user selection 534 comprises a value of “1” for the attribute “Kalle” indicating that “Kalle” is selected, and the user selection 534 comprises a value of “0” for the attribute “Pekka” indicating that “Pekka” is not selected.

The BTI 520 can be consulted to determine that the attribute “Kalle” has a value of “1” in the column 523 corresponding to rows 3 and 4. In an aspect, the inverted index 521 can be consulted to determine that the user selection 534 relates to the position 522 value of “3” which is found in the inverted index 521 at positions 3 and 4, implicating rows 3 and 4 of Table 1. Following path 535, a row state 536 can be generated to reflect the user selection 534 as applied to the rows of Table 2. The row state 536 can comprise a position that corresponds to each row and a value in each position reflecting whether a row was selected. Thus, position 1 of the row state 536 comprises the value “0” indicating that row 1 does not contain “Kalle”, position 2 of the row state 536 comprises the value “0” indicating that row 2 does not contain “Kalle”, position 3 of the row state 536 comprises the value “1” indicating that row 3 does contain “Kalle”, position 4 of the row state 536 comprises the value “1” indicating that row 4 does contain “Kalle”, position 5 of the row state 536 comprises the value “0” indicating that row 5 does not contain “Kalle”, and position 6 of the row state 536 comprises the value “0” indicating that row 6 does not contain “Kalle”.

Following path 537, the row state 536 can be compared with the inverted index 525 to determine the corresponding position 526 contained in the inverted index 525 at positions 3 and 4. The inverted index 525 comprises the corresponding position 526 value of “2” in position 3 and the corresponding position 526 value of “3” in position 4. Following path 538, the corresponding position 526 values of “2” and “3” can be determined to correspond to “Soap” and “Shampoo” respectively in the BTI 524. Thus, the logical inference engine 106 can determine that both “Soap” and “Shampoo” in Table 2 are associated with “Kalle” in Table 2. The association can be reflected in an inferred state 539 in the BTI 524. The inferred state 539 can comprise a column with a row for each attribute in the BTI 524. The column can comprise a value indicated the selection state for each attribute. The inferred state 539 comprises a “0” for “Toothpaste” indicating that “Toothpaste” is not associated with “Kalle”, the inferred state 539 comprises a “1” for “Soap” indicating that “Soap” is associated with “Kalle”, and inferred state 539 comprises a “1” for “Shampoo” indicating that “Shampoo” is associated with “Kalle”.

Following path 540, the inferred state 539 can be compared to the BAI 532 to determine one or more associations between the selection of “Kalle” in Table 2 and one or more attributes in Table 1. As the inferred state 539 comprises a value of “1” in both position 2 and position 3, the BAI 532 can be assessed to determine the values contained in position 2 and position 3 of the BAI 532 (following path 541). Position 2 of the BAI 532 comprises the value “1” which identifies the corresponding position 530 of “Soap” and position 3 of the BAI 532 comprises the value “−1” which indicates that Table 1 does not contain “Shampoo”. Thus, the logical inference engine 106 can determine that “Soap” in Table 1 is associated with “Kalle” in Table 2. The association can be reflected in an inferred state 542 in the BTI 528. The inferred state 542 can comprise a column with a row for each attribute in the BTI 528. The column can comprise a value indicated the selection state for each attribute. The inferred state 542 comprises a “1” for “Soap” indicating that “Soap” is associated with “Kalle”, the inferred state 542 comprises a “0” for “Soft Soap” indicating that “Soft Soap” is not associated with “Kalle”, and the inferred state 542 comprises a “0” for “Toothpaste” indicating that “Toothpaste” is not associated with “Kalle”. Based on the current state of BTIs and BAIs, if the data sources 102 indicate that an update or delta change has occurred to the underlying data, the BTIs and BAIs can be updated with corresponding changes to maintain consistency.

In aspects implementing indexlets, the logical inference engine 106 can apply query language by first performing intra-table inferencing on respective tables. Intra-table inferencing comprises transferring the imposed state of one field to other fields within the same table. In an aspect, intra-table inferencing can comprise computing the union of the index of the active attributes in a user input 504. The intersection of the result of the union operation and record states (i.e. row states 510) is then determined. This result is then intersected with the attribute states 514 of other columns using the inverted index 512. If other selection vectors from a previously provided user input vector 504 has zero active entries, a conflict can be detected. In an aspect, the logical inference engine 106 can resolve the detected conflict. In an aspect, resolving a conflict can include deleting or otherwise eliminating one or more incompatible selections. In another aspect, resolving a conflict can include reverting the data model 501 or a portion of the data model 501, e.g. a table, record, or attribute, to a previous state.

In an aspect, after performing intra-table inferencing, the logical inference engine 106 can perform inter-table inferencing based on the intra-table inferencing output of a plurality of tables, as is depicted in FIG. 5E. In an aspect, intra-table inferencing can include transferring a common field attribute of one table 569 to a child in its branch. In an aspect, this can be performed by running the attribute states 570 output from intra-table inferencing through an attribute-to-attribute (A2A) index 572 referencing the attribute states 574 in a second table 576. In an aspect, the A2A index 572 can be partitioned into one or more indexlets as described herein with respect to other data tables. In another aspect, transferring a common field attribute of one table 569 to a child in its branch by running the attribute states 570 output from intra-table inferencing through a function or logic performing similar functionality as the A2A index 572. For example, a function, service, or other logic can accept as input a pair of symbols and return an indication of whether or not they are related, e.g. TRUE or FALSE. In another aspect, attribute-to-attribute relations can be indicated by user input.

Based on current selections and possible rows in data tables a calculation/chart engine 108 can calculate aggregations in objects forming transient hypercubes in an application. The calculation/chart engine 108 can further build a virtual temporary table from which aggregations can be made. The calculation/chart engine 108 can perform a calculation (e.g., evaluate an expression in response to a user selection/de-selection) via a multithreaded operation. The state-space can be queried to gather all of the combinations of dimensions and values necessary to perform the calculation. In an aspect, the query can be on one thread per object, one process, one worker, combinations thereof, and the like. The expression can be calculated on multiple threads per object. Results of the calculation can be passed to a rendering engine 116 and/or optionally to an extension engine 110.

In an aspect, the calculation/chart engine 108 can receive dimensions, expressions, and sorting parameters and can compute a hypercube data structure containing aggregations along the dimensions. For example, a virtual record can be built with a placeholder for all field values (or indices) needed, as a latch memory location. When all values are assigned, the virtual record can be processed to aggregate the fields needed for computations and save the dimension values in a data structure per row of the resulting hypercube. In such a way, the traversal of the database can be done in an arbitrary way, just depending on requirements provided by memory consumption and indexing techniques used for the particular case at hand.

Optionally, the extension engine 110 can be implemented to communicate data via an interface 112 to an external engine 114. In another aspect, the extension engine 110 can communicate data, metadata, a script, a reference to one or more artificial neural networks (ANNs), one or more commands to be executed, one or more expressions to be evaluated, combinations thereof, and the like to the external engine 112. The interface 112 can comprise, for example, an Application Programming Interface (API). The external engine 114 can comprise one or more data processing applications (e.g., simulation applications, statistical applications, mathematical computation applications, database applications, combinations thereof, and the like). The external engine 114 can be, for example, one or more of MATLAB®, R, Maple®, Mathematica®, combinations thereof, and the like.

In an aspect, the external engine 114 can be local to the associative data indexing engine 100 or the external engine 114 can be remote from the associative data indexing engine 100. The external engine 114 can perform additional calculations and transmit the results to the extension engine 110 via the interface 112. A user can make a selection in the data model of data to be sent to the external engine 114. The logical inference engine 106 and/or the extension engine 110 can generate data to be output to the external engine 114 in a format to which the external engine 114 is accustomed to processing. In an example application, tuples forming a hypercube can comprise two dimensions and one expression, such as (Month, Year, Count (ID)), ID being a record identification of one entry. Then said tuples can be exchanged with the external engine 114 through the interface 112 as a table. If the data comprise births there can be timestamps of the births and these can be stored as month and year. If a selection in the data model will give a set of month-year values that are to be sent out to an external unit, the logical inference engine 106 and/or the extension engine 110 can ripple that change to the data model associatively and produce the data (e.g., set and/or values) that the external engine 114 needs to work with. The set and/or values can be exchanged through the interface 112 with the external engine 114. The external engine 114 can comprise any method and/or system for performing an operation on the set and/or values. In an aspect, operations on the set and/or values by the external engine 114 can be based on tuples (aggregated or not). In an aspect, operations on the set and/or values by the external engine 114 can comprise a database query based on the tuples. Operations on the set and/or values by the external engine 114 can be any transformation/operation of the data as long as the cardinality of the result is consonant to the sent tuples/hypercube result.

In an aspect, tuples that are transmitted to the external engine 114 through the interface 112 can result in different data being received from the external engine 114 through the interface 112. For example, a tuple consisting of (Month, Year, Count (ID)) should return as 1-to-1, m-to-1 (where aggregations are computed externally) or n-to-n values. If data received are not what were expected, association can be lost. Transformation of data by the external engine 114 can be configured such that cardinality of the results is consonant to the sent tuples and/or hypercube results. The amount of values returned can thus preserve associativity.

Results received by the extension engine 110 from the external engine 114 can be appended to the data model. In an aspect, the data can be appended to the data model without intervention of the script engine 104. Data model enrichment is thus possible “on the fly.” A natural work flow is available allowing clicking users to associatively extend the data. The methods and systems disclosed permit incorporation of user implemented functionality into a presently used work flow. Interaction with third party complex computation engines, such as MATLAB® or R, is thus facilitated.

The logical inference engine 106 can couple associated results to the external engine 114 within the context of an already processed data model. The context can comprise tuple or tuples defined by dimensions and expressions computed by hypercube routines. Association is used for determination of which elements of the present data model are relevant for the computation at hand. Feedback from the external engine 114 can be used for further inference inside the inference engine or to provide feedback to the user.

In an aspect, one or more handles that were generated prior to receiving results from the external engine 114 can be updated after the results have been appended to the data model. For example, if one or more values in one or more tables changes because of the results from the external engine 114, an UPDATE operation can be performed to refresh the handles to reflect changes in the underlying data.

A rendering engine 116 can produce a desired graphical object (charts, tables, etc) based on selections/calculations. When a selection is made on a rendered object there can be a repetition of the process of moving through one or more of the logical inference engine 106, the calculation/chart engine 108, the extension engine 110, the external engine 114, and/or the rendering engine 116. The user can explore the scope by making different selections, by clicking on graphical objects to select variables, which causes the graphical object to change. At every time instant during the exploration, there exists a current state space, which is associated with a current selection state that is operated on the scope (which always remains the same).

In an aspect, any aggregation function processed by the associative data indexing engine 100 can be qualified to operate on a subset of records (rather than a current selection of data records and/or all data records). The associative data indexing engine 100 can define alternative aggregation sets based on set analysis (e.g., set expression, etc.). Using set analysis, the associative data indexing engine 100 can support methods to define an aggregation set. The exact compositions of defined aggregation sets may not only depend on desired conditions but also the chart (analysis) they are used in. The associative data indexing engine 100 may execute/perform set analysis (e.g., set expression analysis, etc.) for one or more set expressions determined/extracted from a query, such as an undetermined query (e.g., an imprecise query, an undefined query, an incomplete query, a partially expressed query, a portioned query, etc.), to determine and/or define an aggregation set.

To define an aggregation set for an undetermined query (e.g., an imprecise query, an undefined query, an incomplete query, a partially expressed query, a portioned query, etc.), the associative data indexing engine 100 may consider and/or account for items (e.g., compositional elements, predicates, etc.), constraints (e.g., data constraints, logical constraints, etc.) of the query, and one or more data analysis models (e.g., data charts, data tables, data graphs, data maps, graphical objects, key performance indicators (KPIs), etc.).

For example, the associative data indexing engine 100 may determine how each input item and/or computational element fits a data analysis model based on the data analysis model's capacity and/or projectability of an item (e.g., whether it has any condition, whether the condition results on one or multiple values, etc.). For example, the associative data indexing engine 100 may determine an optimal data analysis model from one or more data analysis models determined (e.g., via the calculation/chart engine 108, etc.) from a query (e.g., an undetermined query or another type of query) that best fits each input item and/or computational element.

For example, the associative data indexing engine 100 may define an aggregation set for each of the following undetermined business-related queries:
Query 1: Sales by product where sales >2000
Query 2: Products with sales >2000
Query 3: Number of products with sales >2000

Query 1, Query 2, and Query 3, each include similar (e.g., conceptually similar, etc.) items (e.g., compositional elements, predicates, etc.), such as “sales,” “products,” “>2000,” and/or the like. The associative data indexing engine 100 may, for example, use natural language parsing and/or metadata analysis to determine the items and/or any constraints of the query, such as a default analysis period, a required data/element selection, and/or the like. The computing device may determine/perform a different set analysis for the Query 1, the Query 2, the Query 3, and/or any other undetermined query based on, for example, an order/arrangement of items (and/or computational elements/constraints) of the query and/or the composition (e.g., dimensions, measures, etc.) of one or more data analysis models (e.g., data charts, data tables, data graphs, data maps, graphical objects, key performance indicators (KPIs), etc.). The computing device may determine/perform a different set analysis for Query 1, Query 2, and Query 3 (and/or any other query) according to novel algorithms described herein.

Compositional elements (e.g., predicates, conditions, data constraints, etc.) of a query and/or query data may be determined. Compositional elements (e.g., predicates, conditions, data constraints, etc.) of the query data may include and/or be based on text/items from the query and corresponding conditional predicate(s). For example, for Query 1, Query 2, and Query 3, the associative data indexing engine 100 may determine example compositional elements shown below:

| Predicate | Condition |
|---|---|
| Sales item | >2000 |
| ProductName | N/A (no condition) |

Metadata for and/or associated with a query (e.g., an undetermined query or another type of query) and/or any compositional element for the undetermined query may be determined. For example, semantic data types may uniformly represent standard data types, compositional elements, validations, formatting rules, and other business logic that may be further used to determine and/or define an aggregation set. Semantic types may be stored as metadata structures that may be used and reused during the process of query analysis.

A set of input items and/or computational elements may be adjusted, for example by the associative data indexing engine 100, to ensure there is no conflict. A query, such as a natural question, may include an explicit time frame, for example, an undetermined query may be “Sales by product, where sales >2000 in 2019,” where the year 2019 is the explicit time frame for the query. The associative data indexing engine 100 may determine that any default time period is unwarranted and/or if the global selections already satisfy any metadata-driven preconditions to use a measure.

The best data analysis model for a query may be determined. For example, the best data analysis model may be a data analysis model most relevant to a query—determined based on how aggregated related data may potentially fit and/or apply to elements, fields, constraints, components, and/or the like of a data analysis model. For example, input items and/or computational elements associated with a rank and/or ranking may be best fitted to a bar chart and/or related data analysis model, input items and/or computational elements associated with values may be best fitted to a table, input items and/or computational elements associated with facts may be best fitted to a KPI and/or related data analysis model.

The associative data indexing engine 100 may determine, for example, a data analysis model most relevant to a query based on the analysis' capacity and also the projectability of an item and/or compositional element and of a query, such as whether the item and/or compositional element is associated with any condition, and/or whether the condition results on one or multiple values. For example, the associative data indexing engine 100 may determine that a rank analysis may accommodate one measure and one dimension. For example, a rank analysis and/or associated data analysis model may be determined for Query 1 (Sales by product where sales >2000) because a rank analysis and/or associated data analysis model may include “sales and measure,” and “product” as dimensions. However, for a slightly modified query such as:
Modified Query 1: Sales by product in Nordic countries where Sales >2000;
   there are two dimensions, “product” and “country,” to choose from, and “product” has no condition which gives it an edge over “country.” In such a situation, the associative data indexing engine 100 may combine items, compositional elements, and/or constraints and determine/generate set expressions. A final set of compositional elements and/or constraints may be combined, for example by the query analysis module 105, for further analysis, for example, by the calculation/chart engine 108.

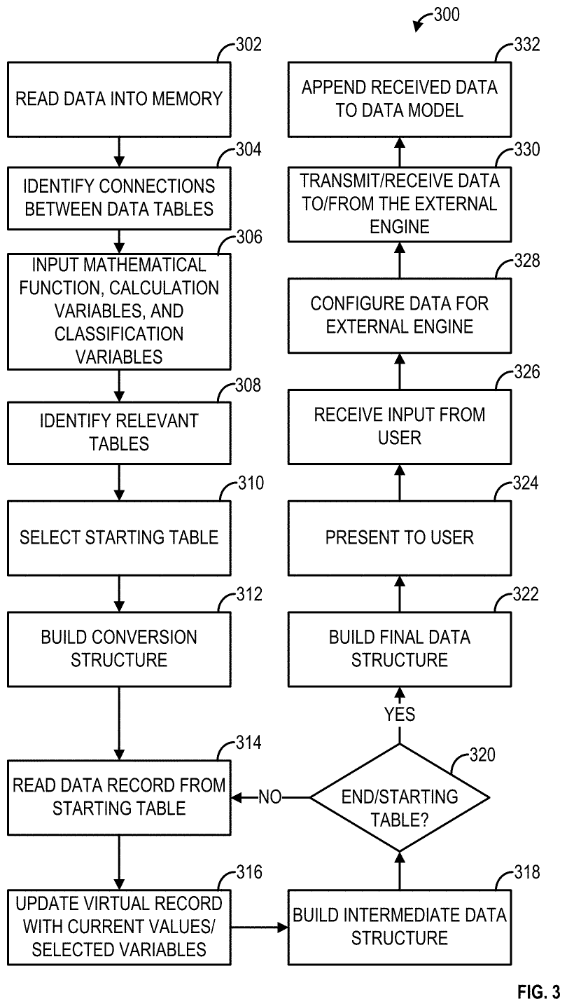

The methods provided can be implemented by means of a computer program as illustrated in a flowchart of a method 300 in FIG. 3 and/or other methods described herein. In an operation 302, the program can read some or all data records in the database, for instance using a SELECT statement which selects all the tables of the database, e.g. Tables 1-5. In an aspect, the database can be read into primary memory of a computer.

To increase evaluation speed, each unique value of each data variable in said database can be assigned a different binary code and the data records can be stored in binary-coded form. This can be performed, for example, when the program first reads the data records from the database. For each input table, the following operations can be carried out. The column names, e.g. the variables, of the table can be read (e.g., successively). Every time a new data variable appears, a data structure can be instantiated for the new data variable. An internal table structure can be instantiated to contain some or all the data records in binary form, whereupon the data records can be read (e.g., successively) and binary-coded. For each data value, the data structure of the corresponding data variable can be checked to establish if the value has previously been assigned a binary code. If so, that binary code can be inserted in the proper place in the above-mentioned table structure. If not, the data value can be added to the data structure and assigned a new binary code, for example the next binary code in ascending order, before being inserted in the table structure. In other words, for each data variable, a unique binary code can be assigned to each unique data value.

After having read some or all data records in the database, the method 300 can analyze the database in a operation 304 to identify all connections between the data tables. A connection between two data tables means that these data tables have one variable in common. In an aspect, operation 304 can comprise generation of one or more bidirectional table indexes and one or more bidirectional associative indexes. In an aspect, generation of one or more bidirectional table indexes and one or more bidirectional associative indexes can comprise a separate operation. In another aspect, generation of one or more bidirectional table indexes and one or more bidirectional associative indexes can be on-demand. After the analysis, all data tables are virtually connected. In FIG. 2, such virtual connections are illustrated by double-ended arrows. The virtually connected data tables can form at least one so-called “snowflake structure,” a branching data structure in which there is one and only one connecting path between any two data tables in the database. Thus, a snowflake structure does not contain any loops. If loops do occur among the virtually connected data tables, e.g. if two tables have more than one variable in common, a snowflake structure can in some cases still be formed by means of special algorithms known in the art for resolving such loops.

After this initial analysis, the user can explore the database and/or define a mathematical function. Assume that the user wants to extract the total sales per year and client from the database in FIG. 2. The user defines a corresponding mathematical function “SUM (x*y)”, and selects the calculation variables to be included in this function: “Price” and “Number.” The user also selects the classification variables: “Client” and “Year.”

Optionally, a mathematical function may be determined for an undetermined query (e.g., an imprecise query, an undefined query, an incomplete query, a partially expressed query, a portioned query, etc.), for example, “Sales by product where sales >2000.” Calculation variables for the undetermined query may include “Product,” “Price,” “Date,” and “Year.”

At operation 306, a mathematical function may be determined. The mathematical function may be, for example, a combination of mathematical expressions. For example, an undetermined query such as “Sales by product where sales >2000,” can be used to extract the total sales of a product where the number (e.g., sale amount, etc.) exceeds 2000. A corresponding mathematical function may be defined, for example by a user as:

=sum({<Set1,Set2>}Sales),

where:
Set1=[Product]={′=Sum({<[QuartersAgo]={0}>}Sales >2000)′}; and
Set2=[QuartersAgo]={0}.

Calculation variables to be included in this function may include “Product” and “Number.” The classification variable “Year” may also be set, for example, by a user.

The method 300 then identifies in operation 308 all relevant data tables, e.g. all data tables containing any one of the selected calculation and classification variables, such data tables being denoted boundary tables, as well as intermediate data tables in the connecting path(s) between these boundary tables in the snowflake structure, such data tables being denoted connecting tables. There are no connecting tables in the present example. In an aspect, one or more bidirectional table indexes and one or more bidirectional associative indexes can be accessed as part of operation 308.

In the present example, all occurrences of every value, e.g. frequency data, of the selected calculation variables can be included for evaluation of the mathematical function. In FIG. 2, the selected variables (“Price,” “Number”) can require such frequency data. Now, a subset (B) can be defined that includes all boundary tables (Tables 1-2) containing such calculation variables and any connecting tables between such boundary tables in the snowflake structure. It should be noted that the frequency requirement of a particular variable is determined by the mathematical expression in which it is included. Determination of an average or a median calls for frequency information. In general, the same is true for determination of a sum, whereas determination of a maximum or a minimum does not require frequency data of the calculation variables. It can also be noted that classification variables in general do not require frequency data.

Then, a starting table can be selected in operation 310, for example, among the data tables within subset (B). In an aspect, the starting table can be the data table with the largest number of data records in this subset. In FIG. 2, Table 2 can be selected as the starting table. Thus, the starting table contains selected variables (“Client,” “Number”), and connecting variables (“Date,” “Product”). These connecting variables link the starting table (Table 2) to the boundary tables (Tables 1 and 3).

Thereafter, a conversion structure can be built in operation 312. This conversion structure can be used for translating each value of each connecting variable (“Date,” “Product”) in the starting table (Table 2) into a value of a corresponding selected variable (“Year,” “Price”) in the boundary tables (Table 3 and 1, respectively). A table of the conversion structure can be built by successively reading data records of Table 3 and creating a link between each unique value of the connecting variable (“Date”) and a corresponding value of the selected variable (“Year”). It can be noted that there is no link from value 4 (“Date: 1999 Jan. 12”), since this value is not included in the boundary table. Similarly, a further table of the conversion structure can be built by successively reading data records of Table 1 and creating a link between each unique value of the connecting variable (“Product”) and a corresponding value of the selected variable (“Price”). In this example, value 2 (“Product: Toothpaste”) is linked to two values of the selected variable (“Price: 6.5”), since this connection occurs twice in the boundary table. Thus, frequency data can be included in the conversion structure. Also note that there is no link from value 3 (“Product: Shampoo”).

When the conversion structure has been built, a virtual data record can be created. Such a virtual data record accommodates all selected variables (“Client,” “Year,” “Price,” “Number”) in the database. In building the virtual data record, a data record is read in operation 314 from the starting table (Table 2). Then, the value of each selected variable (“Client”, “Number”) in the current data record of the starting table can be incorporated in the virtual data record in a operation 316. Also, by using the conversion structure each value of each connecting variable (“Date”, “Product”) in the current data record of the starting table can be converted into a value of a corresponding selected variable (“Year”, “Price”), this value also being incorporated in the virtual data record.

In operation 318 the virtual data record can be used to build an intermediate data structure. Each data record of the intermediate data structure can accommodate each selected classification variable (dimension) and an aggregation field for each mathematical expression implied by the mathematical function. The intermediate data structure can be built based on the values of the selected variables in the virtual data record. Thus, each mathematical expression can be evaluated based on one or more values of one or more relevant calculation variables in the virtual data record, and the result can be aggregated in the appropriate aggregation field based on the combination of current values of the classification variables (“Client,” “Year”).

The above procedure can be repeated for one or more additional (e.g., all) data records of the starting table. In an operation 320 it can be checked whether the end of the starting table has been reached. If not, the process can be repeated from operation 314 and further data records can be read from the starting table. Thus, an intermediate data structure can be built by successively reading data records of the starting table, by incorporating the current values of the selected variables in a virtual data record, and by evaluating each mathematical expression based on the content of the virtual data record. If the current combination of values of classification variables in the virtual data record is new, a new data record can be created in the intermediate data structure to hold the result of the evaluation. Otherwise, the appropriate data record is rapidly found, and the result of the evaluation is aggregated in the aggregation field.

Thus, data records can be added to the intermediate data structure as the starting table is traversed. The intermediate data structure can be a data table associated with an efficient index system, such as an AVL or a hash structure. The aggregation field can be implemented as a summation register, in which the result of the evaluated mathematical expression is accumulated.

In some aspects, e.g. when evaluating a median, the aggregation field can be implemented to hold all individual results for a unique combination of values of the specified classification variables. It should be noted that only one virtual data record is needed in the procedure of building the intermediate data structure from the starting table. Thus, the content of the virtual data record can be updated for each data record of the starting table. This can minimize the memory requirement in executing the computer program.

After traversing the starting table, the intermediate data structure can contain a plurality of data records. If the intermediate data structure accommodates more than two classification variables, the intermediate data structure can, for each eliminated classification variable, contain the evaluated results aggregated over all values of this classification variable for each unique combination of values of remaining classification variables.

In an aspect, operation 322 can involve any of the processes described previously with regard to FIG. 5A-5F as part of a process for creating the hypercube/multidimensional cube. For example, output from the logical inference engine 18 and/or 106 utilizing one or more BTIs and or one or more A2A indexes can be used in creation of the hypercube/multidimensional cube. When a user makes a selection, the inference engine 18 and/or 106 calculates a data subset of which one or more BTIs and/or A2A indexes can be generated and provided to the chart engine 58 and/or calculation/chart 108 for use in generating a hypercube/multidimensional cube and/or evaluating one or more expressions against a hypercube/multidimensional cube via one or more BTIs and/or A2A indexes as described with regard to FIG. 5A-5F.

In an aspect, when the intermediate data structure has been built, a final data structure(s), e.g., data analysis model(s) (e.g., data charts, data tables, data graphs, data maps, key performance indicators (KPIs), etc.), may be created by evaluating the mathematical function based on the results of the mathematical expression contained in the intermediate data structure. In doing so, the results in the aggregation fields for each unique combination of values of the classification variables may be combined.

The data analysis model may be a best fit data analysis model, for example, a data analysis model that best fits compositional elements (e.g., predicates, conditions, data constraints, etc.) of an undetermined query and/or any other query. As explained, a data analysis model most relevant to a query may be based on the analysis' capacity and also the projectability of an item and/or compositional element and of the query, such as whether the item and/or compositional element is associated with any condition, and/or whether the condition results on one or multiple values.

In the example, the creation of the final data structure is straightforward, due to the trivial nature of the present mathematical function. At operation 324, the content of the final data structure may be presented to the user.

At operation 326, input from the user can be received. For example, input from the user can be a selection and/or de-selection of the presented results.

Optionally, input from the user at operation 326 can comprise a request for external processing. In an aspect, the user can be presented with an option to select one or more external engines to use for the external processing. Optionally, at operation 328, data underlying the user selection can be configured (e.g., formatted) for use by an external engine. Optionally, at operation 330, the data can be transmitted to the external engine for processing and the processed data can be received. The received data can undergo one or more checks to confirm that the received data is in a form that can be appended to the data model. For example, one or more of an integrity check, a format check, a cardinality check, combinations thereof, and the like. Optionally, at operation 332, processed data can be received from the external engine and can be appended to the data model as described herein. In an aspect, the received data can have a lifespan that controls how long the received data persists with the data model. For example, the received data can be incorporated into the data model in a manner that enables a user to retrieve the received data at another time/session. In another example, the received data can persist only for the current session, making the received data unavailable in a future session.

FIG. 5A shows how an undetermined query 50 (e.g., an imprecise query, an undefined query, an incomplete query, a partially expressed query, a portioned query, etc.) operates and/or is executed on a data/information 52 to generate a data subset 54. The data subset 54 can form a state space, which is based on the undetermined query 50. In an aspect, the state space (or “user state”) may be defined by a user providing query information via a user interface of an application. For example, the state space may be based on any of the following undetermined business-related queries:
Query 1: Sales by product where sales >2000
Query 2: Products with sales >2000
Query 3: Number of products with sales >2000

Query 1, Query 2, and Query 3, each include similar (e.g., conceptually similar, etc.) items (e.g., compositional elements, predicates, etc.), such as “sales,” “products,” “>2000,” and/or the like. Natural language parsing and/or metadata analysis may be used to determine the items and/or any constraints of the query, such as a default analysis period, a required data/element selection, and/or the like. A different set analysis may be performed for Query 1, Query 2, Query 3, and/or any other undetermined query based on, for example, an order/arrangement of items (and/or constraints) of the query and/or the composition (e.g., dimensions, measures, etc.) of one or more data analysis models (e.g., data charts, data tables, data graphs, data maps, graphical objects, key performance indicators (KPIs), etc.).

One or more items and/or data constraints of a query (e.g., an undetermined query or another type of query) may be used to determine one or more data analysis models. An application can be designed to host a number of data analysis models (e.g., data charts, data tables, data graphs, data maps, graphical objects, key performance indicators (KPIs), etc.) that evaluate one or more mathematical functions (also referred to as an “expression”) on the data subset 54 for one or more dimensions (classification variables). The result of this evaluation creates a data analysis model result 56.

As illustrated in FIG. 5A, when a user selection, such as an undetermined query 50, is received, the inference engine 18 calculates a data subset. Also, an identifier ID1 for the selection together with the scope can be generated based on the filters in the selection and the scope. Subsequently, an identifier ID2 for the data subset is generated based on the data subset definition, for example, a bit sequence that defines the content of the data subset. ID2 can be put into a cache using ID1 as a lookup identifier. Likewise, the data subset definition can be put in the cache using ID2 as a lookup identifier.

As shown in FIG. 5A, a chart (and/or any other data analysis model) calculation in a calculation/chart engine 58 takes place in a similar way. Here, there are two information sets: the data subset 54 and relevant chart (and/or any other data analysis model) properties 60. The latter can be, but not restricted to, a mathematical function together with calculation variables and classification variables (dimensions).

Mathematical functions together with calculation variables and classification variables (dimensions) can be used to calculate the chart result 56, and both of these information sets can be also used to generate identifier ID3 for the input to the chart calculation. ID2 can be generated already in the previous operation, and ID3 can be generated as the first operation in the chart calculation procedure

The identifier ID3 can be formed from ID2 and the relevant chart properties. ID3 can be seen as an identifier for a specific chart generation instance, which can include all information needed to calculate a specific chart result. In addition, a chart result identifier ID4 can be created from the chart result definition, for example, a bit sequence that defines the chart result 56. ID4 can be put in the cache using ID3 as a lookup identifier. Likewise, the chart result definition can be put in the cache using ID4 as a lookup identifier.

Optionally, further calculations, transforming, and/or processing can be included through an extension engine 62. Optionally, associated results from the inference engine 18 and further computed by hypercube computation in said calculation/chart engine 58 can be coupled to an external engine 64 (or, in some cases, an external engine 114) that can comprise one or more data processing applications (e.g., simulation applications, statistical applications, mathematical computation applications, database applications, combinations thereof, and the like). Context of a data model processed by the inference engine 18 can comprise a tuple or tuples of values defined by dimensions and expressions computed by hypercube routines. Data can be exchanged through an interface 66.

The associated results coupled to the external engine 64 can be intermediate. Further results that can be final hypercube results can also be received from the external engine 64. Further results can be fed back to be included in the Data/Scope 52 and enrich the data model. The further results can also be rendered directly to the user in the chart result 56. Data received from and computed by the external engine 64 can be used for further associative discovery.

Each of the data elements of the database shown in Tables 1-5 of FIG. 2 has a data element type and a data element value (for example “Client” is the data element type and “Nisse” is the data element value). Multiple records can be stored in different database structures such as data cubes, data arrays, data strings, flat files, lists, vectors, and the like; and the number of database structures can be greater than or equal to one and can comprise multiple types and combinations of database structures. While these and other database structures can be used with, and as part of, the methods and systems disclosed, the remaining description will refer to tables, vectors, strings, and data cubes solely for convenience.

Additional database structures can be included within the database illustrated as an example herein, with such structures including additional information pertinent to the database such as, in the case of products for example; color, optional packages, etc. Each table can comprise a header row which can identify the various data element types, often referred to as the dimensions or the fields, that are included within the table. Each table can also have one or more additional rows which comprise the various records making up the table. Each of the rows can contain data element values (including null) for the various data element types comprising the record.

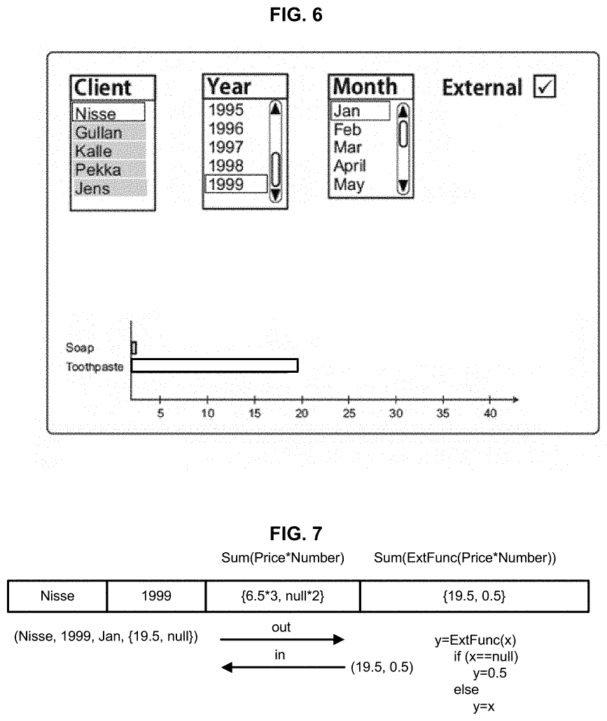

The database as referred to in Tables 1-5 of FIG. 2 can be queried by specifying the data element types and data element values of interest and by further specifying any functions to apply to the data contained within the specified data element types of the database. The functions which can be used within a query can include, for example, expressions using statistics, sub-queries, filters, mathematical formulas, and the like, to help the user to locate and/or calculate the specific information wanted from the database. Once located and/or calculated, the results of a query can be displayed to the user with various visualization techniques and objects such as list boxes of a user interface illustrated in FIG. 6.

The graphical objects (or visual representations) can be substantially any display or output type including graphs, charts, trees, multi-dimensional depictions, images (computer-generated or digital captures), video/audio displays describing the data, hybrid presentations where output is segmented into multiple display areas having different data analysis in each area and so forth. A user can select one or more default visual representations; however, a subsequent visual representation can be generated on the basis of further analysis and subsequent dynamic selection of the most suitable form for the data.

In an aspect, a user can select a data point and a visualization component can instantaneously filter and re-aggregate other fields and corresponding visual representations based on the user's selection. In an aspect, the filtering and re-aggregation can be completed without querying a database. In an aspect, a visual representation can be presented to a user with color schemes applied meaningfully. For example, a user selection can be highlighted in green, datasets related to the selection can be highlighted in white, and unrelated data can be highlighted in gray. A meaningful application of a color scheme provides an intuitive navigation interface in the state space.

The result of a standard query can be a smaller subset of the data within the database, or a result set, which is comprised of the records, and more specifically, the data element types and data element values within those records, along with any calculated functions, that match the specified query. For example, as indicated in FIG. 6, the data element value “Nisse” can be specified as a query or filtering criteria as indicated by a frame in the “Client” header row. In some aspects, the selected element can be highlighted in green. By specifically selecting “Nisse,” other data element values in this row are excluded as shown by gray areas. Further, “Year” “1999” and “Month” “Jan” are selected in a similar way.

Optionally, in this application, external processing can also be requested by ticking “External” in the user interface of FIG. 6. Data as shown in FIG. 7 can be exchanged with an External engine 64 through the interface 66 of FIG. 5A. In addition to evaluating the mathematical function (“SUM (Price*Number)”) based on the results of the mathematical expression (“Price*Number”) contained in the intermediate data structure the mathematical function (“SUM (ExtFunc(Price*Number))”) can be evaluated. Data sent out are (Nisse, 1999, Jan, {19.5, null}). In this case the external engine 64 can process data in accordance with the formula

```
if (x==null)
  y=0.5
else
  y=x
```

as shown in in FIG. 7. The result input through the interface 66 will be (19.5, 0.5) as reflected in the graphical presentation in FIG. 6.

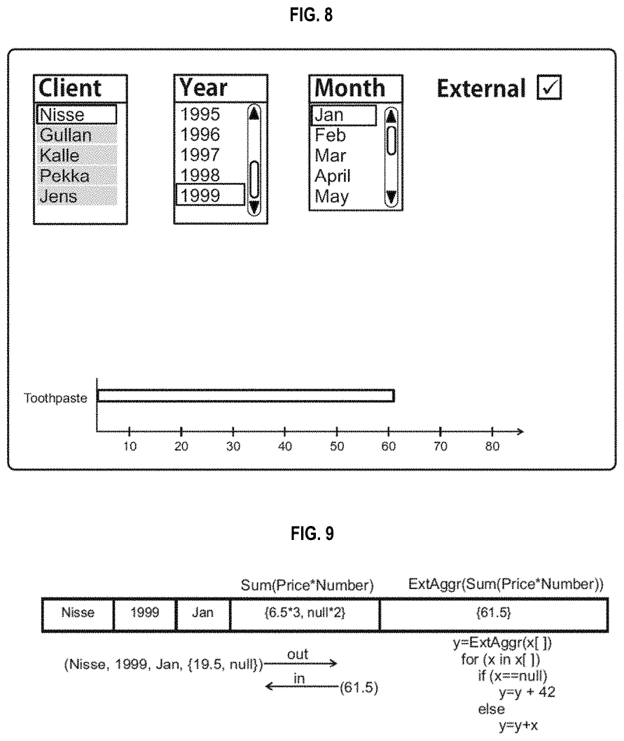

In a further aspect, external processing can also be optionally requested by ticking “External” in a box as shown in FIG. 8. Data as shown in FIG. 9 can be exchanged with an external engine 64 through the Interface 66 of FIG. 5A. In addition to evaluating the mathematical function (“SUM(Price*Number)”) based on the results of the mathematical expression (“Price*Number”) contained in the intermediate data structure the mathematical function:

SUM(ExtFunc(Price*Number))

can be evaluated. Data sent out are (Nisse, 1999, Jan, {19.5, null}). In this case, the external engine 64 will process data in accordance with Function (1) as shown below and in FIG. 9. The result input through the Interface 66 will be (61.5) as reflected in the graphical presentation in FIG. 8.

```
y=ExtAggr(x[ ])
  for (x in x[ ])
    if (x==null)
      y=y + 42
    else
      y=y+x
Function (1)
```

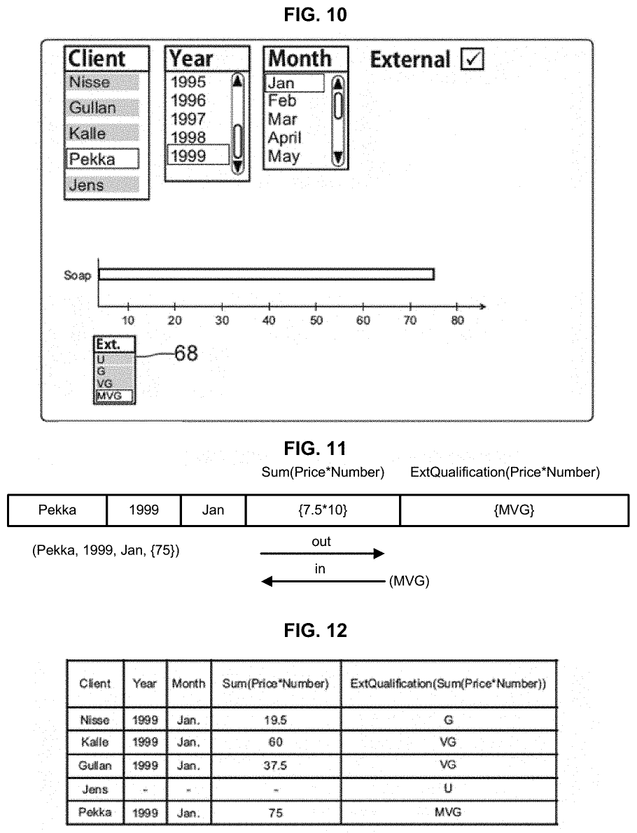

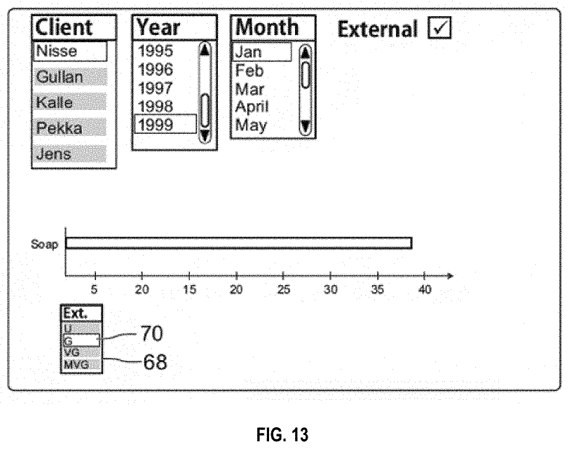

A further optional embodiment is shown in FIG. 10 and FIG. 11. The same basic data as in previous examples apply. A user selects “Pekka,” “1999,” “Jan,” and “External.” By selecting “External,” already determined and associated results are coupled to the external engine 64. Feedback data from the external engine 64 based on an external computation, ExtQualification(Sum(Price*Number)), as shown in FIG. 13 will be the information “MVG.” This information can be fed back to the logical inference engine 18. The information can also be fed back to the graphical objects of FIG. 10 and as a result a qualification table 68 will highlight “MVG” (illustrated with a frame in FIG. 10). Other values (U, G, and VG) are shown in gray areas. The result input through the Interface 66 will be Soap with a value of 75 as reflected in the graphical presentation (bar chart) of FIG. 10. FIG. 11 is a schematic representation of data exchanged with an external engine based on selections in FIG. 10. FIG. 12 is a table showing results from computations based on different selections in the presentation of FIG. 10.

Should a user instead select “Gullan,” “1999,” “Jan,” and “External,” the feedback signal would include “VG” based on the content shown in qualification table 68. The computations actually performed in the external engine 62 are not shown or indicated, since they are not relevant to the inference engine.

In FIG. 13 a user has selected “G” as depicted by 70 in the qualification table 68. As a result information fed back from the external engine 64 to the external engine 62 and further to the inference engine 18 the following information will be highlighted: “Nisse,” “1999,” and “Jan” as shown in FIG. 13. Furthermore, the result produced will be Soap 37.5 as reflected in the graphical presentation (bar chart) of FIG. 13.

A result of the various embodiments disclosed herein is a business analytic solution. The business analytic solution operates on the data stored and/or generated (e.g., hypercube/multidimensional cube, various indexes, etc. . . . ) by the disclosed embodiments. Users of the business analytic solution can query the data to obtain insight into the data. The query can be made, for example, by specifying data element types and data element values of interest and by further specifying any functions to apply to the data contained within the specified data element types of the database. The functions which can be used within a query can include, for example, expressions using statistics, sub-queries, filters, mathematical formulas, and the like, to help a user to locate and/or calculate the specific information wanted from the database. Once located and/or calculated, the results of a query can be displayed to the user with various visualization techniques and objects such as list boxes or various charts of a user interface. In another aspect, a result of the query can be displayed not only as visualizations but in the form of natural language, providing the user an insight overview across data sources and/or data tables.

Provided herein, among other things, is a “smart” DSS and related analytic techniques. The DSS and related techniques form a business analytic solution. For example, the business analytic solution can make reasonable defaults at various operations of an analysis, from data preparation, to building the data model, and preparing visual and/or text analyses. In an aspect, the business analytic solution can guide users to make sensible choices in order to quickly get to both expected answers and new answers (e.g., new insights). The business analytic solution enables a user to find unknown insights from the data and presents it to the user with the use of the systems and methods disclosed herein.

Domain experts, such as data architects, or visualization experts, are sources to provide rules (e.g., defaults and guidelines, usually in the form of generic best practices) for data analysis. Similarly, specific precedents that are established by users or a community of users who actually use the data are also sources of rules (e.g., defaults and guidelines) for data analysis. The disclosed embodiments, individually or in particular combinations, can provide an optimized technique to capture and represent such rules. Given the heuristic nature of such rules, the disclosed embodiments can utilize precedents to capture both types of rules (e.g., domain expert rules and user rules). Such precedents can then be utilized in a system that, given a specific context, can locate applicable precedents (for example, by similarity and/or generalization) and use those precedents to enable smart data analysis behavior.

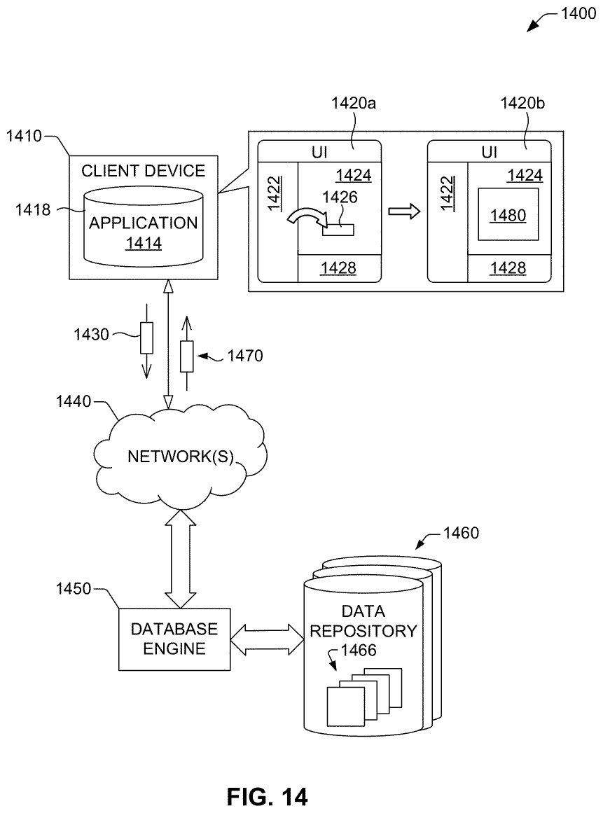

FIG. 14 illustrates an example of an operating environment 1400 for composition of query using a user interface and visualization of data responsive to the query, in accordance with one or more embodiments of this disclosure. The operating environment 100 includes a client device 1410 that can execute a client application 1414. Execution of the client application 1414 results in the application 1414 being loaded to a system memory device 1418 from a non-volatile memory device (such as a mass storage device; not depicted in FIG. 14). Execution of the application 1414 can permit composing a query according to a defined data model and/or data context, as is described herein. The client application 1414 can be embodied in a web browser, a mobile application, or similar software application executable in the client device 1410. The client device 1410 can be embodied in, for example, a personal computer (PC), a laptop computer, a tablet computer, a smartphone, or similar device.

Execution of the client application 1414 can cause the client device 1410 to present a sequence of user interfaces, including a user interface 1420a and a user interface 1420b. The user interface 1420a permits interactively configuring a data model or data context, or both. The user interface 1420a provides, via the client application 1410, drag-and-drop functionality that permits generating a query based at least on the data model or the data context, or both. The user interface 1420b can be a redrawn or otherwise updated version of the user interface 120a, and permits the visualization of data responsive to the query. A display device (not depicted in FIG. 14) that can be integrated into the client device 1410, or is functionally coupled thereto, can present the sequence of user interfaces 1420.

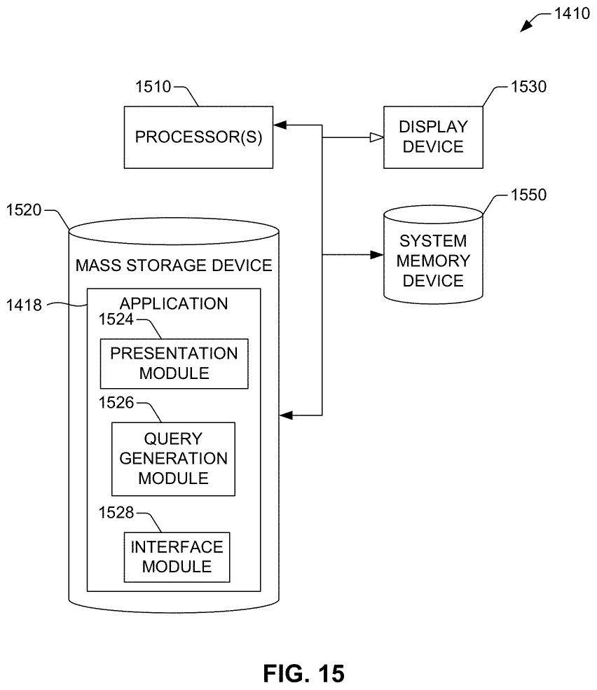

More specifically, the client device 1410 can execute the client application 1414 and, in response, the client device 1410 can cause presentation of the user interface 1420a. The user interface 1420a can include a configuration pane 1422 and a viewport pane 1424. In some cases, as is shown in FIG. 14, the user interface 1420b also can include a review pane 1428, where a table or other data can be presented. As is shown in FIG. 14, the area of the user interface 1420a can be partitioned into the configuration pane 1422, the viewport pane 1424, and in some cases, the review pane 1428. Such panes are arranged adjacent to one another. As is shown in FIG. 15, the client device 1410 can include one or more processors 1510 that can execute the client application 1418. An executable version of the client application 1418 can be retained in a non-volatile memory device 1520 and, in response to execution can be loaded to a system memory device 1550. The client application 1410 can include a presentation module 1524. In response to being executed, the presentation module 1524 can cause or otherwise direct a display device 1530 to present the user interface 1420a. It is noted that in FIG. 15, the display device can be functionally coupled to a bus of the client device 1410 via one or more components, such as an Input/Output controller device (not shown). Such component(s) are pictorially represented with an open-head arrow.

The configuration pane 1422 can include multiple selectable visual elements that can be selected, individually or in combination, in order to define a data model and/or data context. The defined data model and/or data context can be used to generate a query 1430. To that end, the client device 1410 can determine, based on a first interaction with the user interface 1420a, a selection of a first element defining a data model. The first interaction with the UI can be a drag-and-drop action, which is represented by a curved arrow in the user interface 1420a. The drag-and-drop action can originate in the configuration pane 1422 and can terminate at the viewport pane 1424. In some cases, a section represented by a UI element 1426 can serve as terminal point. To determine such a selection, the client device 1410 can execute, or can continue executing, the presentation module 1524 (FIG. 15). In addition, the client device 1410 can determine, based on a second interaction with the user interface, a selection of a second element defining a data context. The second interaction with the UI also can be a drag-and-drop action. In this disclosure, a drag-and-drop action can have many forms depending on the architecture of the client device 1410 or the display device 1530, or both. In cases where peripheral devices are functionality coupled to the client device and have been configured for use, a drag-and-drop action can be click-and-move action from a defined element in the configuration pane 1422 to the section 1426. In cases where the display device 1530 includes a touch-screen device, the draft-and-drop action can be a swipe gesture from a first contact point overlaying the configuration pane 1422 and corresponding to a defined element to a second contact point overlaying the viewport pane 1424 and corresponding to the section 1426.

The client device 1410 can generate the query 1430 based on the data model and the data context that have been selected. To that end, the client device 1410 can execute, or can continue executing, a query generation module 1526 (FIG. 15). In some cases, generating the query can include generating a set expression including an outer expression and an inner expression. The outer expression defines a scope of data available to the inner expression. More specifically, the set expression can be materialized as a bitmask on top of the original dataset, and the relations between a first set handle (corresponding to the outer expression) and an inner set handle (corresponding to the inner expression) is the resulting slice of data on which aggregations can be computed. In this disclosure, for purposes of illustration, an aggregation can be a function having a domain that is multi-dimensional (e.g., multiple fields or rows in a table) and an image that is a single dimensional (e.g., a number). Thus, the aggregation maps a dataset into a defined value. By defining the inner set expression and the outer set expression in terms of respective inner and outer set handles, a grammar for the query can be defined in terms of a set algebra for the inner set handle and the outer set handle.

The query generation module 1526 can format the query 130 according to JavaScript object notation (JSON) format. As such, the query 130 can be cast as an update to a prior query 130, in some cases. Accordingly, subsequent changes to a prior query can be accomplished by sending a small amount of data to the database engine. In that way, computational efficiency can be improved relative to existing technologies.

The client device 1410 can send the query 1430 to a computing platform configured to execute the query 1430 against one or more databases. To that end, the client device 1410 can execute, or can continue executing, an interface module 1528 (FIG. 15). The interface module 1528 can send the query 1430 to the computing platform by means of one or more networks 1440. The network(s) 1440 can include wired link(s) and/or wireless link(s) and several network elements (such as routers or switches, concentrators, servers, and the like) that form a communication architecture having a defined footprint. The network(s) 1440 can be embodied in a local area network (LAN), a metropolitan area network (MAN), a wide area network (WAN), or a combination thereof.

The computing platform can be remotely located relative to the client device 1410, and includes a database engine 1450 functionally coupled to one or more data repositories 1460 (referred to as data repository 1460). The database engine 1450 can be embodied in, or can include, the data indexing engine 100, in some embodiments. The database engine 1450 can execute the query 1430 against one or more particular tables of the multiple tables 1466. The particular table(s) can be defined by the data context. As a result, the database engine 1450 can generate data 1470 responsive to the query 1430. The database engine 1450 can send the data 1470 to the client device 1410. As is illustrated in FIG. 14, the data 1470 can be sent via the network(s) 1440. The interface module 1528 (FIG. 15) can receive the data 1470.

In response to receiving the data 1470, the client device 1410 can cause presentation of the data 1470 within the viewport pane 1424 of the user interface 1420b. As mentioned, the user interface 1420b can be an updated version of the user interface 1420a. Causing presentation of the data can include causing presentation of a graphical object 1480 within the viewport pane 1424 of user interface 1420b. Thus, in response to receiving the data 1470, the client device 1410, via the presentation module 1524 (FIG. 15) can cause or otherwise direct the display device 1530 (FIG. 15) to redraw the user interface 1420a to include the graphical object 1480. The graphical object 1480 conveys the data via, for example, multiple graphical elements (such as lines, blocks, circles, text, and the like; not depicted in FIG. 14). The graphical object 1480 is formatted according to a particular data visualization format that can be selected from a group of multiple data visualization formats. The particular visualization format defines type(s), arrangement(s), and/or attribute(s) of the graphical visual elements. Simply as an illustration, the group of multiple data visualization formats can include IDK, a chart format, a table format, a plot format, a KPI format, treeman format, and geochart format. The disclosure is, of course, not limited in that respect. Indeed, the client device 1410, via the presentation module 1524 (FIG. 15), for example, can generate the graphical object by hypercubes (aggregations of different types). As such, client device 1410 has substantial flexibility to generate complex, rich graphical objects to visualize the data 1470.

In further response to receiving the data 1470, the client device 1410, via the presentation module 1524 (FIG. 15), also can cause presentation of source data (a table, for example) corresponding to the data model defined by selecting one or more defined elements of the configuration pane 1422. The source data can be presented within the review pane 1428. Thus, in response to receiving the data 1470, the client device 1410, via the presentation module 1524 (FIG. 15) can cause or otherwise direct the display device 1530 (FIG. 15) to redraw the user interface 1420a to include the source data within the review pane 1428 of the user interface 1420b.

Updates to a defined data model and/or a defined data context also can be defined interactively. In some cases, instead of generating an updated query, the query 1430 can be resolved against a different database consistent the updated data model. More specifically, the client device can determine, based on a new interaction with the user interface 1420b, a selection of a third element updating one of the defined data model and/or the defined data context. Similar to other interactions described herein, the new interaction with the user interface 1420b also can be a drag-and-drop action. As mentioned, rather than generating an updated query based on the updated data model and/or updated data context, the client device can send the query 1430 to the computing platform. The interface module 1528 (FIG. 15) can send the query 1430 to the computing platform.

The database engine 1450 can execute the query 1430 against a database according to the updated data model, using one or more tables of the multiple tables 1466. Such table(s) can be identified by the multiple tables 1466. The database engine 1450 can send updated data 1470 responsive to the query 1430 to the client device 1410. The interface module 1528 (FIG. 15) can receive the updated data 1470.

The client device 1410 can cause presentation of the updated data 1470 within the viewport pane 1424 of the user interface 1420b. In some embodiments, causing presentation of the updated data 1470 can include updating the graphical object 1480, and causing presentation of the updated graphical object 1480 within the viewport pane 1424 of the user interface 1420b. The updated graphical object 1480 depicts the updated data 1470. In some cases, the client device can receive, via the presentation module 1524, for example, input data indicative of selection of a particular visualization format for the updated graphical object 1480. In response, the client device 1410 can redraw the updated graphical object 1480 according to that particular visualization format.

The user interface 1420b can include, in some cases, a defined selectable visual element that, in response to being selected, permits editing the query 1430 that has been generated. Accordingly, in some embodiments, the client device 1410 can receive input data indicative of selection of the defined selectable visual element (not shown in FIG. 15). That input data can be received via the presentation module 1524 (FIG. 15), for example. In response to receiving such input data, the presentation module 1524 can cause presentation of another user interface (not shown in FIG. 14 or FIG. 15) that permits editing the query 1430. For example, the presentation module 1524 can cause or otherwise direct the display device 1530 to present that another user interface (not shown in FIG. 14 and FIG. 15) configured to edit the query 1430. To that point, the second user interface can include an edition pane that presents the query 1430 and is configured to receive input data defining one or more changes to the query 1430.

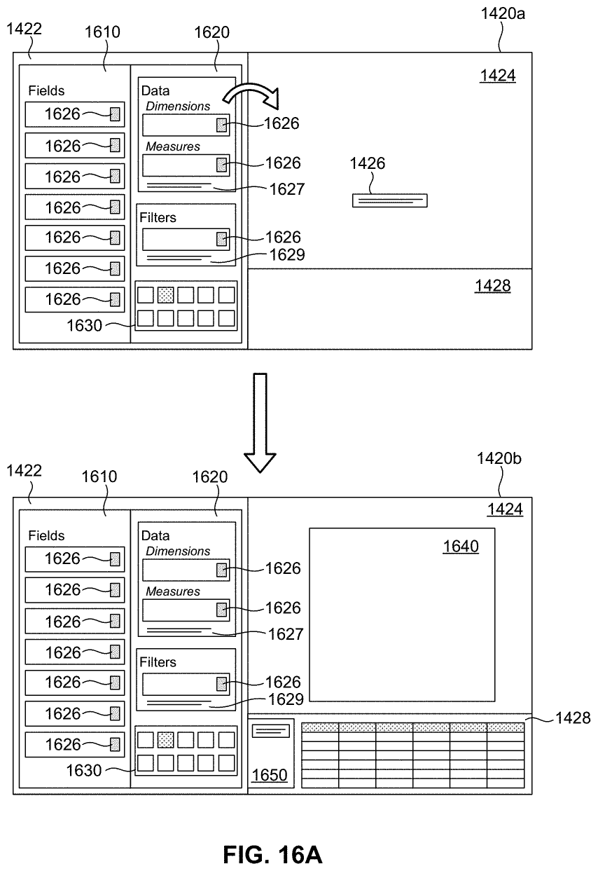

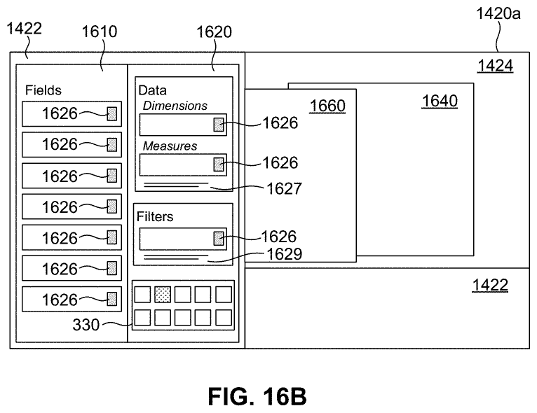

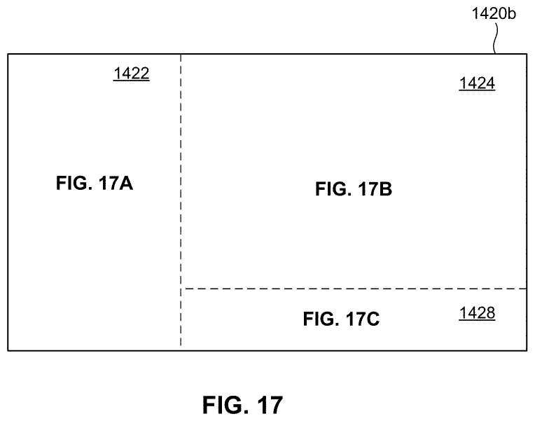

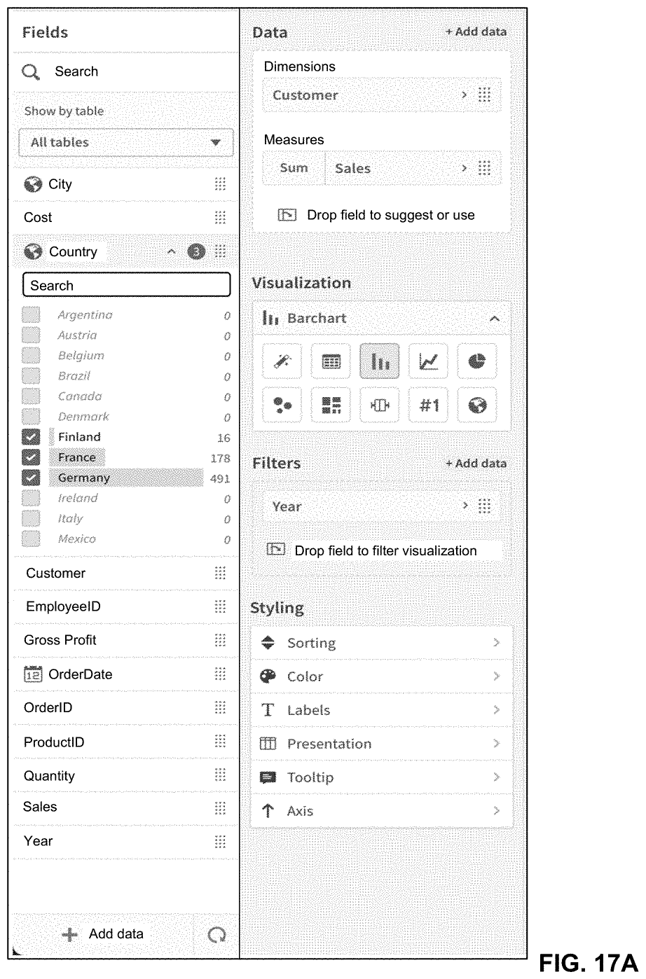

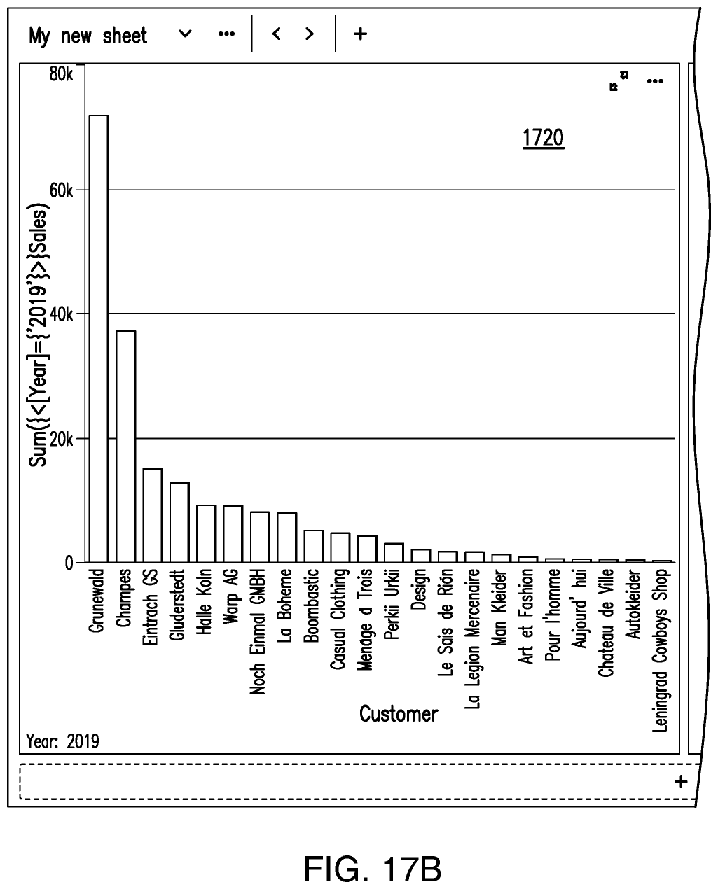

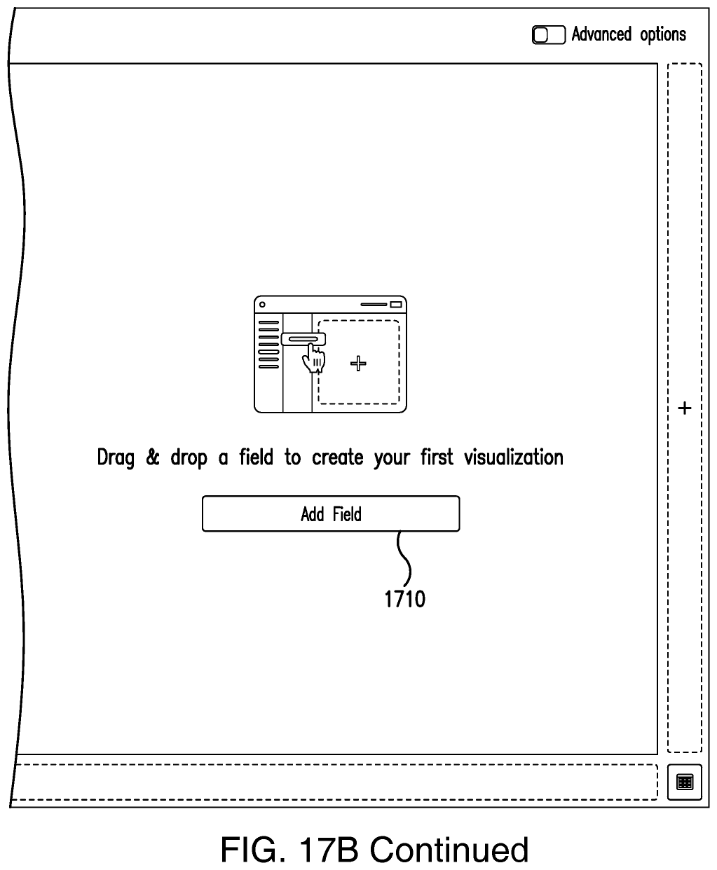

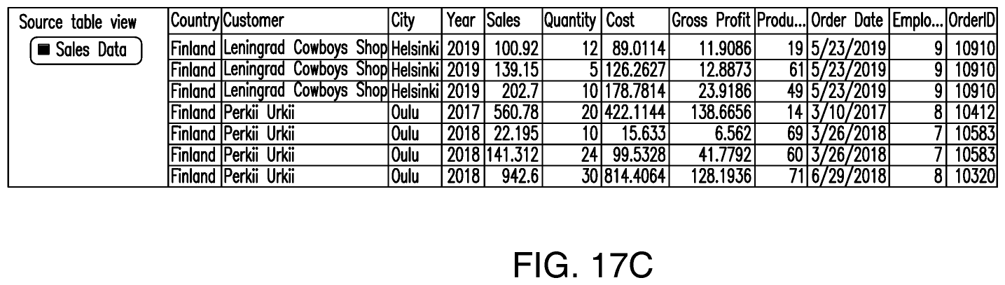

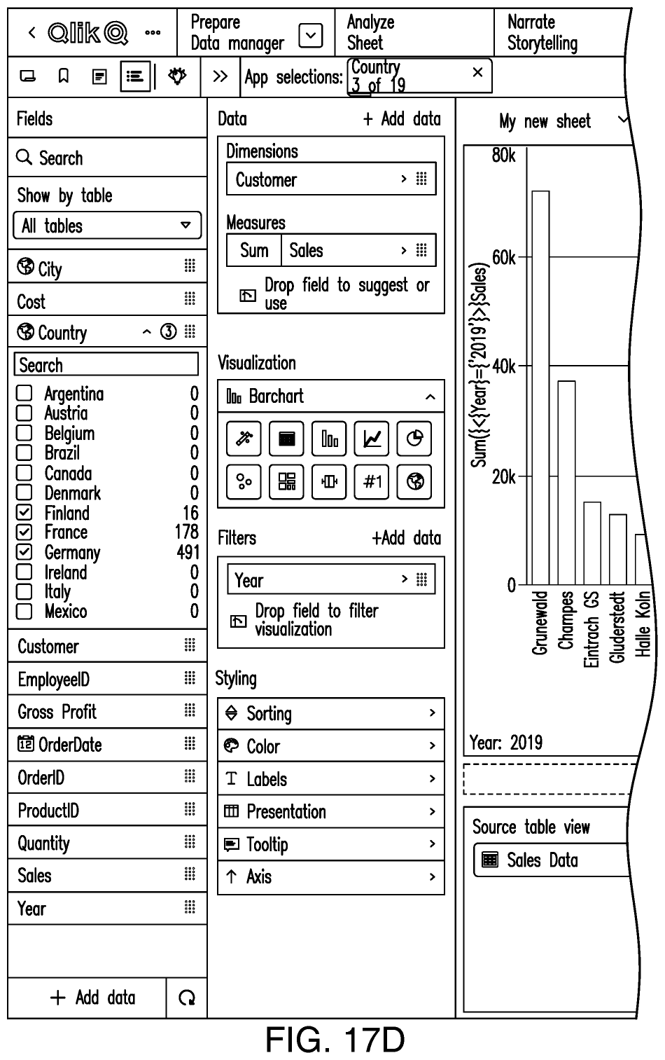

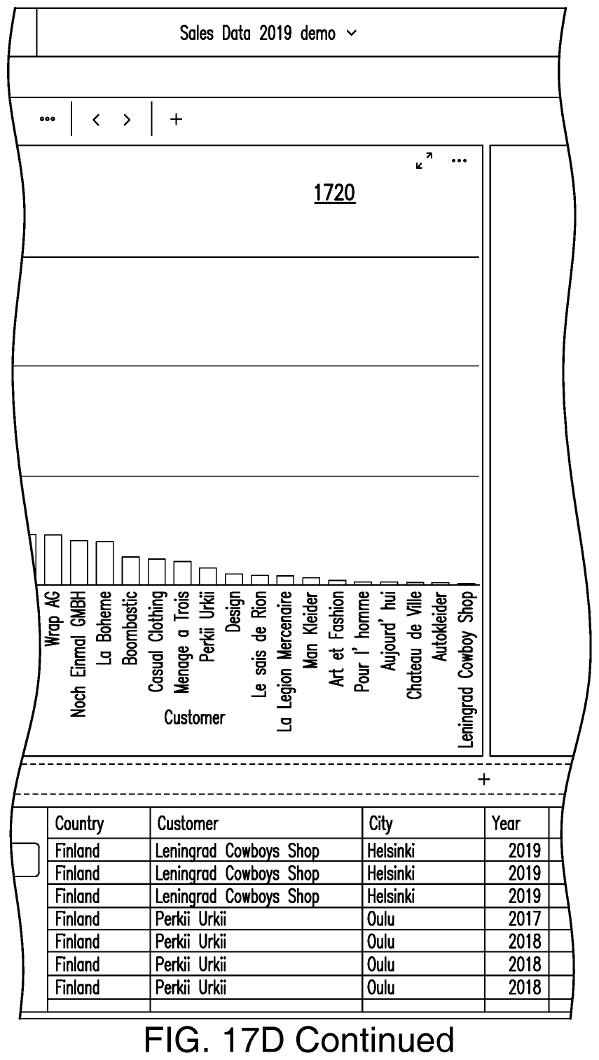

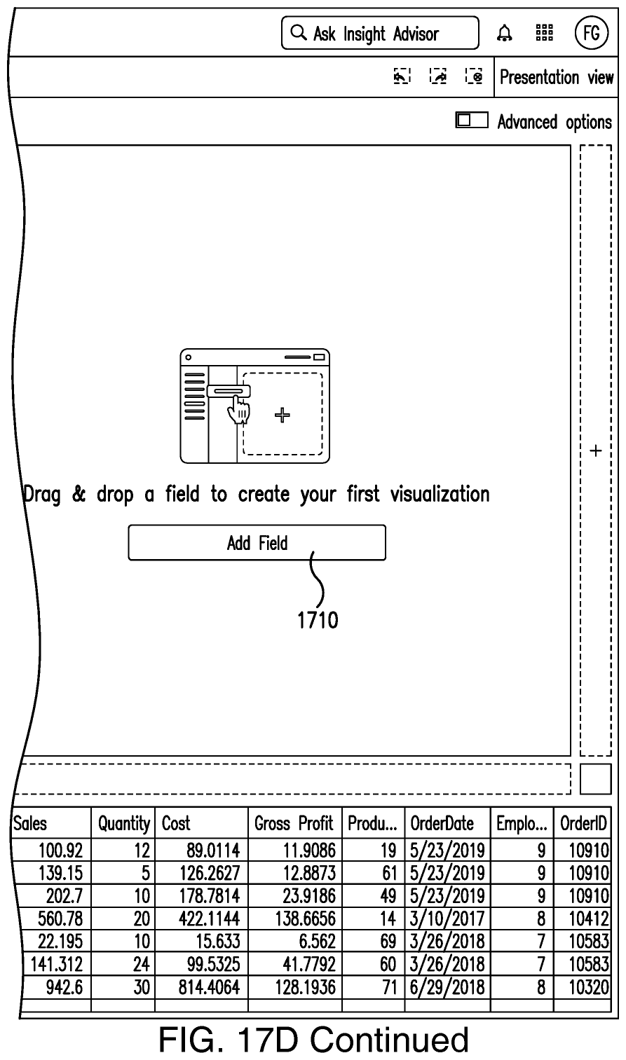

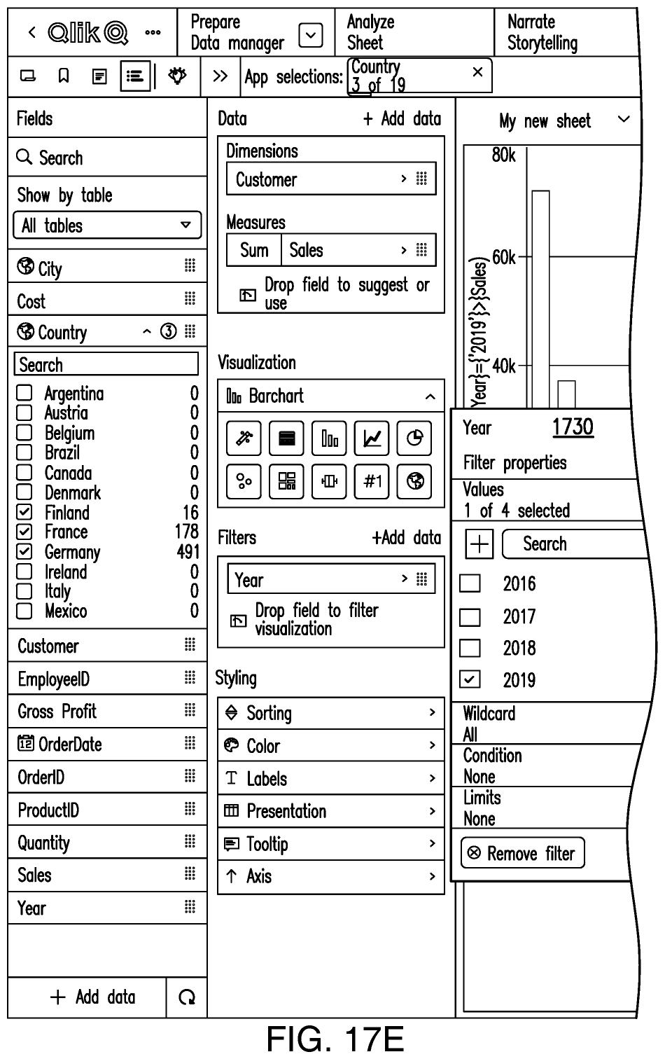

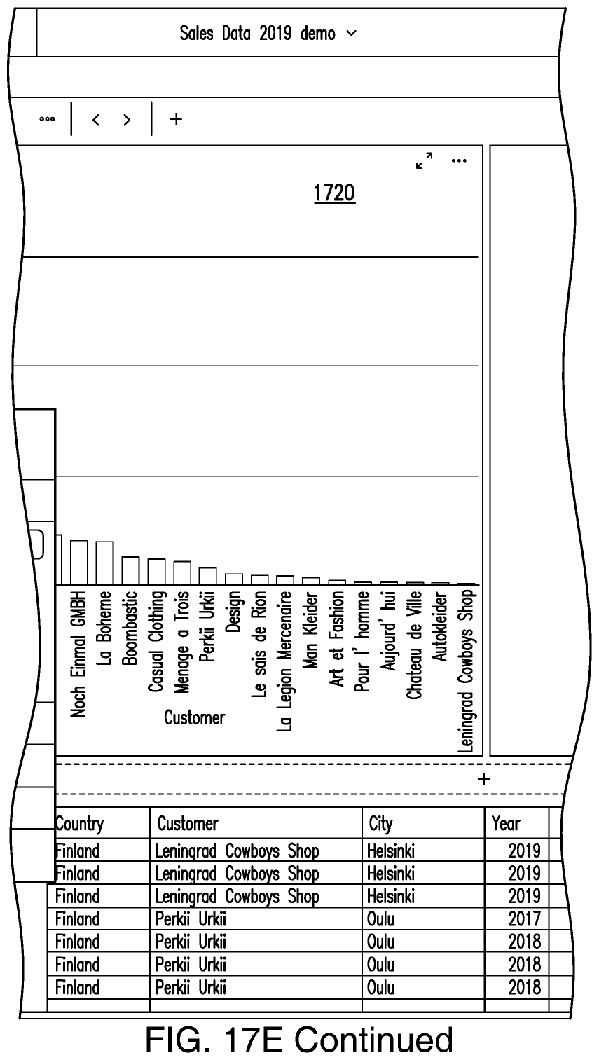

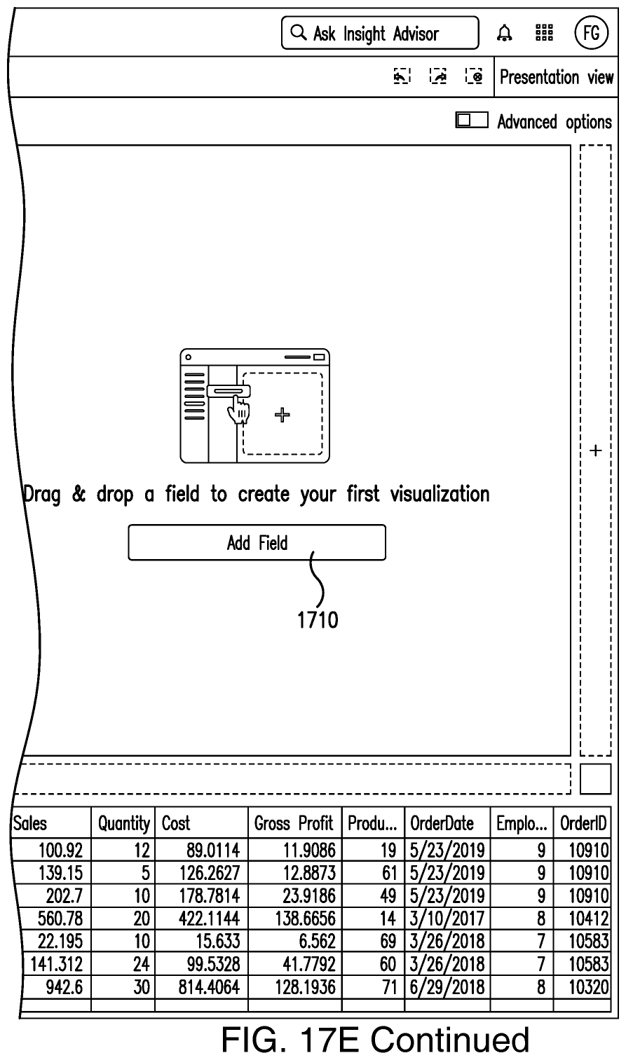

FIG. 16A illustrates examples of user interfaces and example behavior corresponding to query composition and data visualization, in accordance with one or more embodiments of this disclosure. The configuration pane 1422 can include a first section 1610 that includes multiple visual elements identifying respective fields within a table, for example. Each one of the multiple visual elements includes a selectable visual element 1626 that, in response, to being selected can cause presentation of a menu of selectable options to select a value or instance of the field. In addition, or in some embodiments, the menu of selectable options also can include an option to search available values for a field (e.g., Country, as is shown in FIG. 17A). To perform such a search, in some embodiments, the client device 1410 can access a utility module. The utility module can be part of the application 1418 or can be accessed as a service via an API, for example. As is illustrated in FIG. 17B, examples of fields include City, Country, Customer, EmployeeID, Gross Profit, OrderDate, OrderID, ProductID, Quantity, Sales, and Year. Multiple fields can be selected. Selection of one or multiple fields can define, at least partially, a data model.

The first section 1610 also can include selectable elements that provide other functionalities. For example, the first section 1610 can include a selectable visual element that, in response to being selected, cause the client device 1410 to search for available tables. The tables, individually or in combination, can define, at least partially, a data model. To perform a search, the client device 1410 can send a request for one or more available tables from the tables 1466. As another example, the first section 1410 also can include a selectable visual elements that, in response to being selected, cause the client device 1410 to obtain additional data. The data can be obtained from the data repository 1460, for example. Again, the client device 1410 can access a utility module to perform a search and/or add data. The utility module can be part of the application 1418 or can be accessed as a service via an API, for example.

The configuration pane 1422 also includes a second section 1620 that permits defining, at least partially, a data model. To that end, the second section 1620 includes a Data subsection having a first UI element that permits selection of a dimension and a second UI element that permits selection of a measure. It is noted that in some cases, a dimension can coincide with a field and, in other cases, a dimension can included multiple fields. Further, in yet other cases, a dimension can be derived from a set of one or more fields, which dimension can be referred to as a calculated dimension. Markings, such as text (e.g., “Dimensions”) can indicate the type of the first UI element. The first UI element includes a selectable visual element 1626 that, in response to being selected, cause presentation of menu of dimension options (not depicted in FIG. 16A). Other markings, such as text (e.g., “Measures”) can indicate the type of the second UI element. The second UI element includes a selectable visual element 1626 that, in response to being selected, cause presentation of a menu of measures option (not depicted in FIG. 16A). The Data subsection also can include markings 1627 (e.g., text) prompting or otherwise indicating to drop an element (or field (or dimension)) to the viewport pane 1424 to use. For example, the markings can be embodied in the clause “Drop field to suggest or use,” as is shown in FIG. 17A. In some cases, the Data subsection can include a selectable visual elements that, in response to being selected, cause the client device 1410 to obtain additional data. The data can be obtained from the data repository 1460, for example. Again, the client device 1410 can access a utility module to perform a search and/or add data. The utility module can be part of the application 1418 or can be accessed as a service via an API, for example.

The second section 1620 also includes a Filters subsection that can permit defining a data context for the data model defined by a field, a dimension, a measure, or a combination thereof. Selection of the selectable visual element 1626 within the Filters subsection can cause presentation of a menu of filtering options (not depicted in FIG. 16A). In some embodiments, the second section 1620 includes other subjection(s) that permit configuring the format of some graphical element of the graphical object 1640. For example, as is shown in FIG. 17A, a Styling subsection can be included in the second section 1620. The Filter subsection also can include markings 1629 (e.g., text) prompting or otherwise indicating to drop an element (or field) to the viewport pane 1424 to apply a filter to data being visualized. For example, the markings can be embodied in the clause “Drop field to filter visualization,” as is shown in FIG. 17A. In some cases, the Filter subsection can include a selectable visual elements that, in response to being selected, cause the client device 1410 to obtain additional data. The data can be obtained from the data repository 1460, for example. Again, the client device 1410 can access a utility module to perform a search and/or add data. The utility module can be part of the application 1418 or can be accessed as a service via an API, for example.

In response to an element being selected and dragged-and-dropped into the section 1426, the client device 1410 can redraw the user interface 1420a as user interface 1420b, to present a graphical object 1640 conveying data responsive to the query 1430 generated in response to the drag-and-drop operation. The element can be a dimension, a measure, or a filter. The graphical object 1640 can be presented according to a particular data visualization format. As mentioned, the particular data visualization format can be selected from a group of data visualization formats. The group of data visualization formats can be conveyed, in some cases, by multiple selectable UI elements corresponding to respective ones of the data visualization formats. The multiple UI elements can be contained in a Visualization subsection 1630 within the second section 1620, for example. Selection of one of the multiple selectable UI elements causes a particular data visualization format to be configured for presentation, and also causes the selected UI element to be presented according to indicia that distinguishes the selected UI element from other selectable UI elements in the Visualization subsection 1630.

In further response to the element being dragged-and-dropped into the section 1426, records within a table or a portion of the table (e.g., particular rows) can be presented in the review pane 1428. Indicia providing a description of the table and/or identifying the table can be presented in a section 1650 within the review pane 1428.

As is described herein, after the graphical object 1640 has been presented, further selections can be made within the configuration pane 1422. For example, a filter can be selected. To that end, the selectable visual element 1626 within the Filters subsection can be selected. Such a selection can cause presentation of an overlay element 1660 that overlays the graphical object 1640 within the viewport pane 1424, as is shown in FIG. 16B. An example of the overlay element 1660 is shown in FIG. 17B.

In addition, also after the graphical object 1640 has been presented, another data visualization format may be selected from the Visualization subject 1630. By permitting various selections of data visualization formats after the presentation of the graphical object 1640, the data 1470 can be readily explored in numerous ways, without relying on direct manipulation of the data 1470 by an end-user.

FIG. 17 schematically depicts an example of a user interface 1420b, in accordance with one or more embodiments of this disclosure. FIG. 17A illustrates a section of the user interface 1420b schematically depicted in FIG. 17, where the section represents the configuration pane 1422, in accordance with one or more embodiments of this disclosure. FIG. 17B illustrates another section of the user interface 1420b schematically depicted in FIG. 17, where this other section represents the viewport pane 1424, in accordance with one or more embodiments of this disclosure. The viewport pane 1420 includes an example graphical object 1720 formatted according to a selection of a data visualization format (barchart; see FIG. 17A).

FIG. 17C illustrates another section of the user interface 1420b schematically depicted in FIG. 17, where this other section represents the review pane 1428, in accordance with one or more embodiments of this disclosure.

FIG. 17E illustrates another example of a user interface, in accordance with one or more embodiments of this disclosure. In FIG. 17E, an overlay element 1730 is shown on the viewport 1424. As is described herein, the overlay element 1730 permits selecting one or more elements that defines a filter that can be applied to data conveyed in the graphical object 1720. The overlay 1730 can include, in some cases, an option to search available values (or attributes) for configuration of a filter. To search for such values, the client device 1410 can access a utility module. The utility module can be part of the application 1418 or can be accessed as a service via an API, for example.

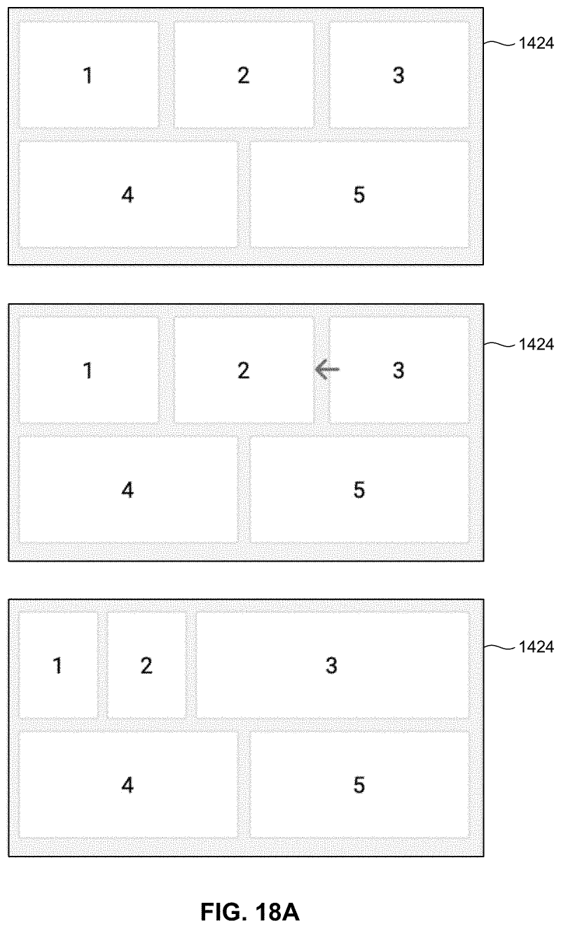

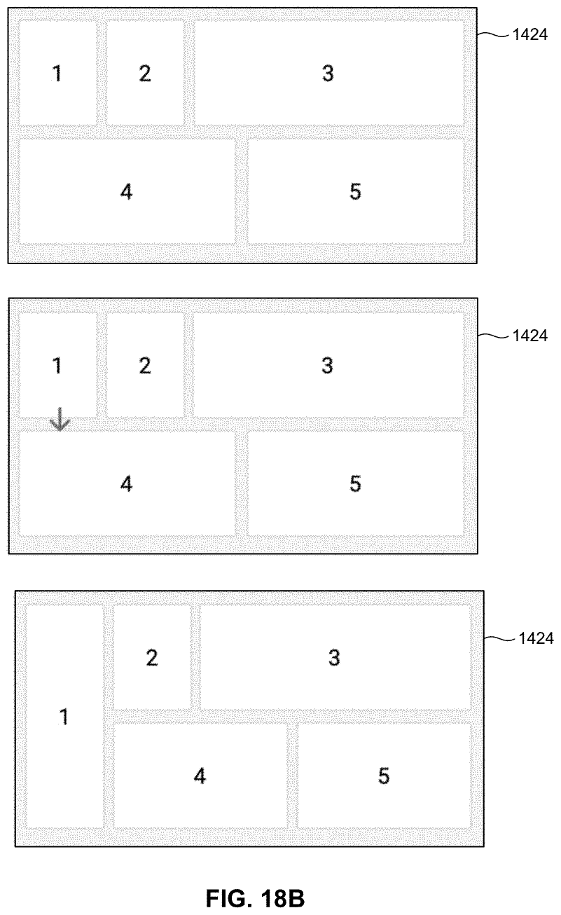

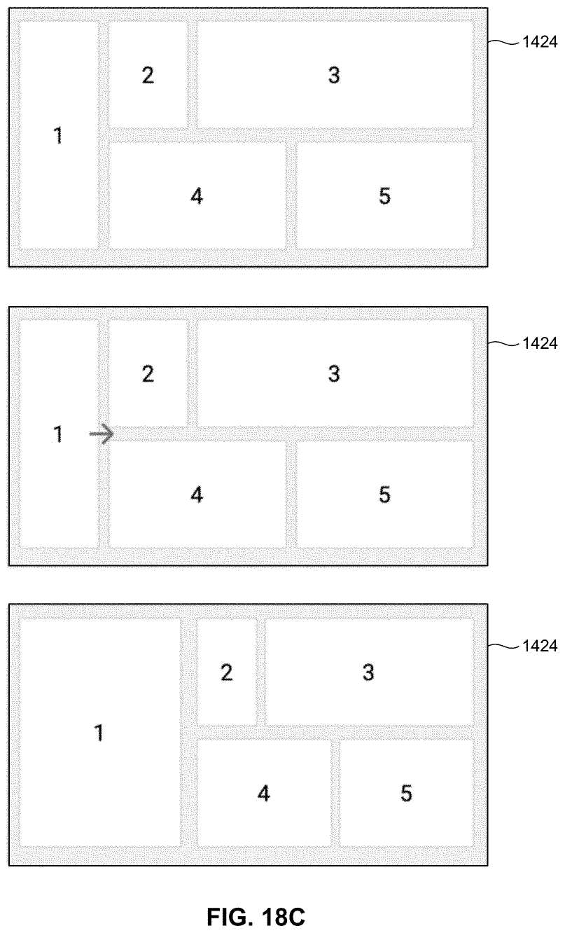

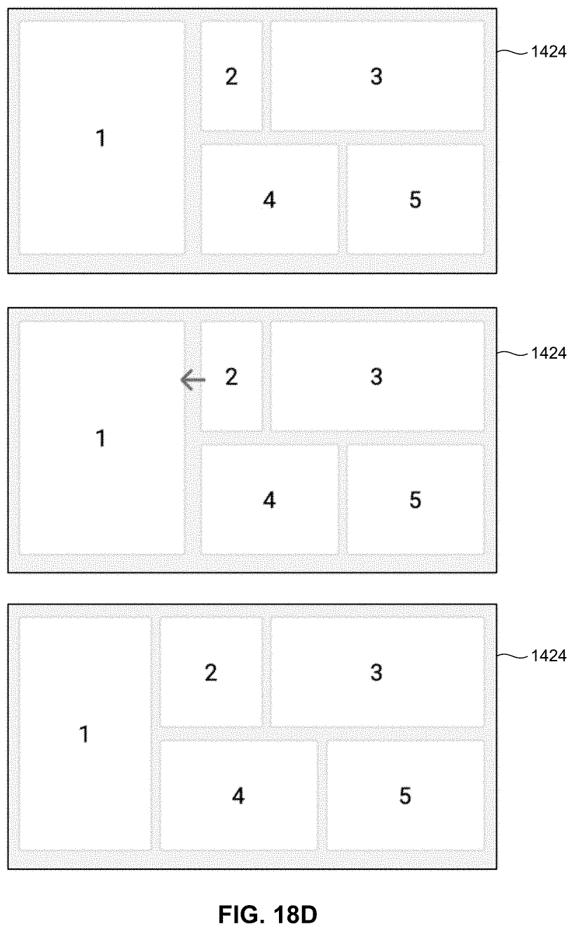

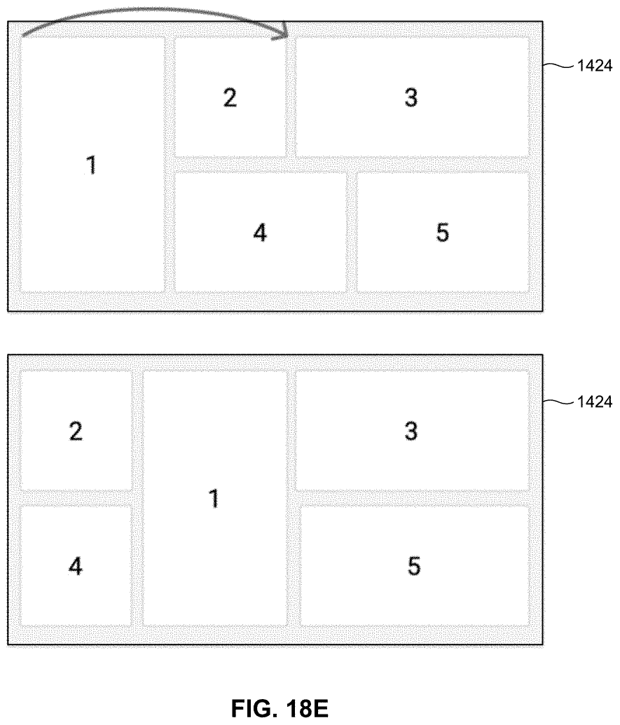

As is indicated in FIG. 17A, for example, more than one drag-and-drop interaction with the user interface 1420b can be performed relative to the viewport pane 1424. As a result, the client device can generate various queries and also can receive data responsive to those queries. In some cases, the queries can be generated in sequence, one after the other, as a drag-and-drop interaction occurs. For those queries, respective graphical objects can be presented in the viewport pane 1424. As an example, FIG. 18A illustrates an example of the viewport pane 1424 having a layout of areas, each area corresponding to a graphical object. Each area in the layout has a defined geometry. Some of the areas can have a same first geometry and size, and other areas can have a same second geometry and size. As is shown in FIG. 18A, the layout includes two rows of areas. The graphical objects corresponding to respective areas in the layout include first graphical object (labeled “1”), a second graphical object (labeled “2”), a third graphical object (labeled “3”), a fourth graphical object (labeled “4”), and a fifth graphical object (labeled “5”).

The client device 1410, via the presentation module 1524 (FIG. 15), for example, can permit interactive modification of the layout of areas and, thus, the arrangement of corresponding graphical objects. To that end, each graphical object included in the layout of areas can be selectable. A bounding box defining the area that contains a graphical object also can be selectable. Indeed, portions of the bounding box, such as a side or a vertex, also can be individually selectable. The presentation module 1524 can determine that a portion of a bounding box or a graphical object within the bounding box has been selected. In response to such a determination, the presentation module 1524 can track movement of the selected element. Additionally, in response to that movement, the presentation module 1524 can modify the geometry and/or size of one or more other bounding boxes that are adjacent to the selected element. The presentation module 1524 can modify the geometry and/or size of the other one or more bounding boxes by solving a two-dimensional packing optimization problem with respect to placement of the areas within the layout of areas, constrained to a defined total visualization area within viewport pane 1424. Other constraints can be imposed on that optimization problem, such as a threshold size(s) (e.g., minimum size(s) and/or maximum size(s)) for each one of the bounding boxes included in the layout of areas. A constraint that also can be incorporated into the optimization problem is preservation, or substantial preservation, of relative sizes of the one or more other bounding boxes while geometry and/or size of the selected bounding box (or graphical object) is modified. Solving such an optimization problem yields a solution that defines a satisfactory arrangement of the graphical objects within an updated layout of areas. By determining such a selection and tracking the movement of the selected element, the presentation module 1524 can update the viewport pane 1424 and can cause the display device 1530 to present the updated viewport pane 1424 as it is updated.

The particular selection and movement constitute an interaction with the viewport pane 1424 and define a modification action that can change the structure of the layout. For example, as is illustrated in FIG. 18A, selection of a side of the bounding box containing graphical object 3 and movement of that side (represented by an arrow) can result in the graphical object 3 being resized. By resizing the graphical object 3, the layout of areas containing the graphical objects 1 to 5 also is updated.

Other interactions with the graphical objects can be performed. Each one of those interactions can define respective modification actions. For example, as is illustrated in FIG. 18B, a resize action can be performed to modify the size of graphical object 1 after the modification of graphical object 3.

Some of the interactions can be directed to a particular graphical object presented in the view port 1424 and can be performed in sequence. For example, the resize action shown in FIG. 18B can be followed by another resize action directed to the graphical object 1, as is shown in FIG. 18C. Further, another resize action can be directed to the graphical object 2 shown in FIG. 18D, after the graphical object 1 has been resized as is shown in FIG. 18C. The resulting layout after resizing the graphical object 2 has updated areas for graphical object 1 and graphical object 2, is shown in FIG. 18D.

Besides resize actions, the presentation module 1524 can permit performing transpose actions. A transpose action is an operation that changes the position of a graphical object to a new position between other adjacent objects, while preserving the geometry and size of the graphical object. Such a transpose action also can change the geometry and/or size of those other adjacent objects. To that end, the presentation module 1524 can determine that a graphical object shown in the viewport pane 1424 has been selected. Again, in response to the selection, the presentation module 1524 can detect a drag operation that moves the graphical object from an initial position to a terminal position (that is, the position of the graphical object after movement has ceased). As an example, FIG. 18E illustrates a transpose action applied to the graphical object 1, where the graphical object 1 is moved from an initial position to a position between graphical object 2 and graphical object 3.

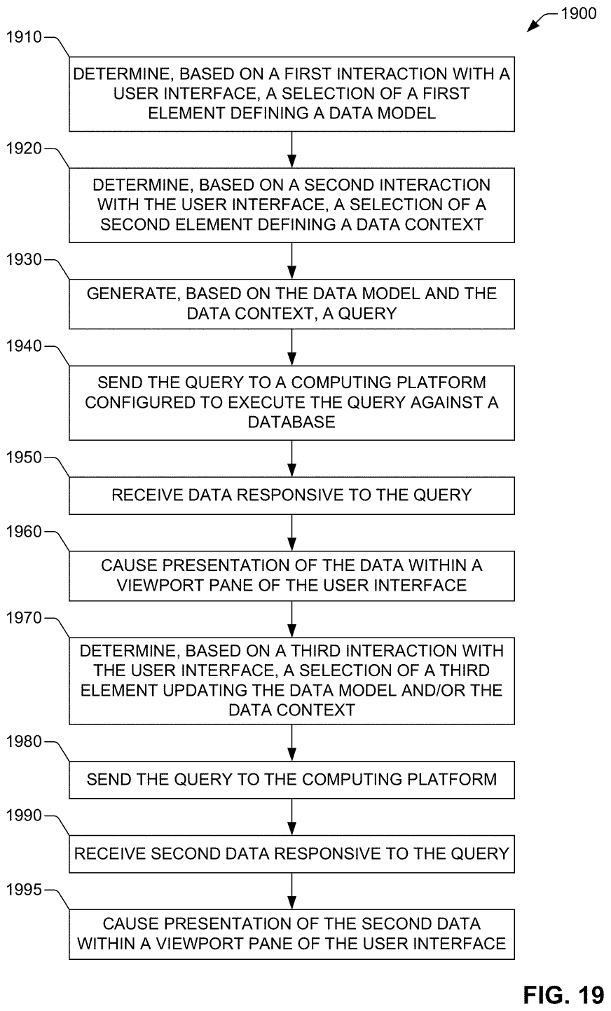

FIG. 19 is a flowchart of an example method 1900 for composing queries using a user interface, in accordance with one or more embodiments of this disclosure. A computing device or a system of computing devices can implement the example method 1900 in its entirety or in part. To that end, each computing device can include computing resources that can implement, or can permit implementing, at least one of the blocks included in the example method 1900. The computing resources include, for example, central processing units (CPUs), graphics processing units (GPUs), tensor processing units (TPUs), memory, disk space, incoming bandwidth, and/or outgoing bandwidth, interface(s) (such as I/O interfaces or APIs, or both); controller devices(s); power supplies; a combination of the foregoing; and/or similar resources. For instance, the system of computing devices can include programming interface(s); an operating system; software for configuration and or control of a virtualized environment; firmware; and similar resources.

The computing device can embody, or can include, the client device 1410 (FIG. 14). Thus, the computing device can host the application 1418 among other components. As such, the computing device can host the presentation module 1524 (FIG. 15), the query generation module 1526 (FIG. 15), and the interface module 1530 (FIG. 15). Accordingly, the computing device can implement the example method 1800, entirely or partially, via the foregoing modules in accordance with aspects described herein.

At block 1910, the computing device can determine, based on a first interaction with a user interface (e.g., user interface 1420a), a selection of a first element defining a data model. The first interaction with the UI can be a drag-and-drop action. Such a determination can be implemented by performing the example method 1900 shown in FIG. 19 and described hereinafter.

At block 1920, the computing device can determine, based on a second interaction with the user interface (e.g., user interface 1420a), a selection of a second element defining a data context. The second interaction with the UI can be a drag-and-drop action. Such a determination can be implemented by performing the example method 1900 shown in FIG. 19 and described hereinafter.

At block 1930, the computing device can generate, based on the data model and the data context, a query. In some cases, generating the query can include generating a set expression including an outer expression and an inner expression. The outer expression defines a scope of data available to the inner expression. The query that is generated can be formatted according to JSON format.

The user interface can include, in some cases, a defined selectable visual element that, in response to being selected, permits editing the query that has been generated. Accordingly, although not illustrated in FIG. 19, in some embodiments, the example method 1900 can include a block where the computing device can receive input data indicative of selection of the defined selectable visual element. Additionally, and while also not shown in FIG. 19, the example method 1900 can include a block where the computing device can cause presentation of a second user interface configured to edit the query generated at block 1930. As is described herein, the second user interface can include an edition pane that presents the query (or the set expression) and is configured to receive input data defining one or more changes to the query (or the set expression).

At block 1940, the computing device can send the query to a computing platform configured to execute the query against a database. As mentioned, in one example, the computing platform can include the database engine 1450 and the data repository 1460.

At block 1950, the computing device can receive, from the computing platform, data responsive to the query. The data can be received by means of a network architecture (at least one of the network(s) 1440 (FIG. 14), for example).

At block 1960, the computing device can cause presentation of the data within a viewport pane of the user interface. In one example, the second data can be presented within the viewport pane 1424 within the user interface 1420b, as is shown in FIG. 14). Causing presentation of the data can include causing presentation of a graphical object within the viewport pane of user interface. The graphical object conveys the data via, for example, multiple graphical elements, such as lines, blocks, circles, text, and the like. The graphical object is formatted according to a particular data visualization format that can be selected from a group of multiple data visualization formats. The particular visualization format defines type(s), arrangement(s), and/or attribute(s) of the graphical visual elements.

At block 1970, the computing device can determine, based on a third interaction with the user interface, a selection of a third element updating one of the defined data model or the defined data context. The third interaction with the UI can be a drag-and-drop action. Rather than generating an updated query based on the updated data model and/or updated data context, the computing device can send the query to the computing platform at block 1980.

At block 1990, the computing device can receive, from the computing platform, second data responsive to the query.

At block 1995, the computing device can cause presentation of the second data within the viewport pane of the user interface. In one example, the second data can be presented within the view portpane 1424 within the user interface 1420b, as is shown in FIG. 14. In some embodiments, causing presentation of the second data can include updating the graphical object depicting the data, and causing presentation of the updated graphical object within the viewport pane of the user interface, the updated graphical object depicting the second data.

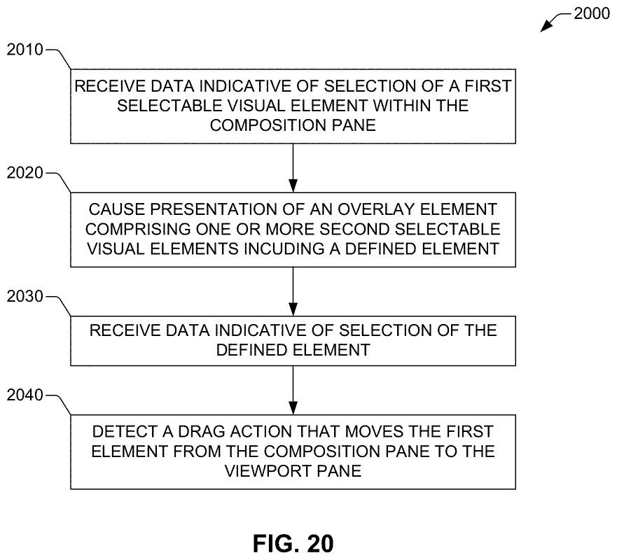

FIG. 20 is a flowchart of an example method 2000 for determining or otherwise identifying selection of an element (a field, for example) within a user interface, in accordance with one or more embodiments of this disclosure. The element defines, at least partially, a data model and/or a data context. A computing device or a system of computing devices can implement the example method 2000 in its entirety or in part. To that end, each computing device can include computing resources that can implement, or can permit implementing, at least one of the blocks included in the example method 2000. The computing resources include, for example, CPUs, GPUs, TPUs, memory, disk space, incoming bandwidth, and/or outgoing bandwidth, interface(s) (such as I/O interfaces or APIs, or both); controller devices(s); power supplies; a combination of the foregoing; and/or similar resources. For instance, the system of computing devices can include programming interface(s); an operating system; software for configuration and or control of a virtualized environment; firmware; and similar resources. The computing device or system of computing devices that implements the example method 2000 also can implement the example method 2000.

The computing device can be embodied in, or can include, the client device 1410 (FIG. 14). Thus, the computing device can host the application 1418 among other components. As such, the computing device can host the presentation module 1524 (FIG. 15), the query generation module 1526 (FIG. 15), and the interface module 1530 (FIG. 15). Accordingly, the computing device can implement the example method 2000, entirely or partially, via the foregoing modules in accordance with aspects described herein.

The user interface can include a configuration pane and a viewport pane. For example, the configuration pane can be the configuration pane 1422 (FIG. 14), and the viewport pane can be the viewport pane 1424 (FIG. 14). At block 2010, the computing device can receive input data indicative of selection of a first selectable visual element within the configuration pane (which also may be referred to as composition pane).

At block 2020, the computing device can cause presentation of an overlay element overlaying a section of the user interface. The overlay element includes one or more second selectable visual elements. The second selectable visual element(s) can include a defined element that defines, at least partially, the data model and/or the data context.

At block 2030, the computing device can receive input data indicative of selection of the defined element.

At block 2040, the computing device can detect a drag action that moves the defined element from the configuration pane to the viewport pane.

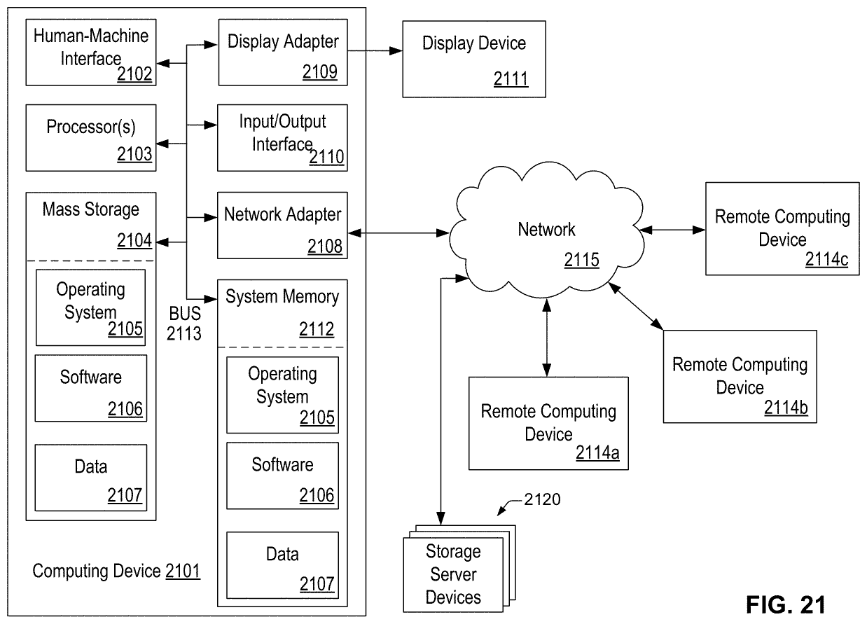

In order to provide some context, the computer-implemented methods, devices, and systems of this disclosure can be implemented on the computing environment illustrated in FIG. 21 and described below. Similarly, the computer-implemented methods and systems disclosed herein can utilize one or more computing devices to perform one or more functions in one or more locations. FIG. 21 is a block diagram illustrating an example of a computing environment 700 for performing the disclosed methods and/or implementing the disclosed systems. The computing environment 2100 shown in FIG. 21 is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The computer-implemented methods and systems in accordance with this disclosure can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set-top boxes, programmable consumer electronics, network PCs, minicomputers, mainframe computers, distributed computing environments that comprise any of the above systems or devices, and the like.

The processing of the disclosed computer-implemented methods and systems can be performed by software components. The disclosed systems and computer-implemented methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed computer-implemented methods can also be practiced in grid-based and distributed computing environments where tasks are performed by remote processing devices that are linked through a communications network. In a distributed computing environment, program modules can be located in both local and remote computer storage media including memory storage devices.

Further, the systems and computer-implemented methods disclosed herein can be implemented via a general-purpose computing device in the form of a computing device 2101. The components of the computing device 2101 can comprise, but are not limited to, one or more processors 2103, a system memory 2112, and a system bus 2113 that functionally couples various system components including the one or more processors 2103 to the system memory 2112. The system can utilize parallel computing.

The system bus 2113 represents one or more of several possible types of bus structures, including a memory bus or memory controller, a peripheral bus, an accelerated graphics port, or local bus using any of a variety of bus architectures. The bus 2113, and all buses specified in this description can also be implemented over a wired or wireless network connection and each of the subsystems, including the one or more processors 2103, one or more mass storage devices 2104 (referred to as mass storage 2104), an operating system 2105, software 2106, data 2107, a network adapter 2108, the system memory 2112, an Input/Output Interface 2110, a display adapter 2109, a display device 2111, and a human-machine interface 2102, can be contained within one or more remote computing devices 2114a,b,c at physically separate locations, connected through buses of this form, in effect implementing a fully distributed system.

The computing device 2101 typically comprises a variety of computer-readable media. Exemplary readable media can be any available media that is accessible by the computing device 2101 and comprises, for example and not meant to be limiting, both volatile and non-volatile media, removable and non-removable media. The system memory 2112 comprises computer readable media in the form of volatile memory, such as random access memory (RAM), and/or non-volatile memory, such as read only memory (ROM). The system memory 2112 typically contains data such as the data 2107 and/or program modules such as the operating system 2105 and the software 2106 that are immediately accessible to and/or are presently operated on by the one or more processors 2103.

The computing device 2101 can also comprise other removable/non-removable, volatile/non-volatile computer storage media. As an example, FIG. 21 illustrates the mass storage 2104 which can provide non-volatile storage of computer code, computer readable instructions, data structures, program modules, and other data for the computing device 2101. For example and not meant to be limiting, the mass storage 2104 can be embodied in, or can include, a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage 2104, including by way of example, the operating system 2105 and the software 2106. Each of the operating system 2105 and the software 2106 (or some combination thereof) can comprise elements of the programming and the software 2106. The data 2107 can also be stored on the mass storage 2104. The data 2107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems. The software 2106 can include, in some cases, the presentation module 1524, the query generation module 1526, and the interface module 1528. In some embodiments, the software 2106 also can include the utility component described herein. Execution of the software 2106 by the processor(s) 2103 can cause the computing device 2101 to provide at least some of the functionality described herein connection with query composition using a user interface and/or visualization of data responsive to the query as is described herein.

In another aspect, the user can enter commands and information into the computing device 2101 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the one or more processors 2103 via the human-machine interface 2102 that is coupled to the system bus 2113, but can be connected by other interface and bus structures, such as a parallel port, game port, an IEEE 1394 Port (also known as a Firewire port), a serial port, or a universal serial bus (USB).

In yet another aspect, the display device 2111 can also be connected to the system bus 2113 via an interface, such as the display adapter 2109. It is contemplated that the computing device 2101 can have more than one display adapter 2109 and the computing device 2101 can have more than one display device 2111. For example, the display device 2111 can be a monitor, an LCD (Liquid Crystal Display), or a projector. In addition to the display device 2111, other output peripheral devices can comprise components such as speakers (not shown) and a printer (not shown) which can be connected to the computing device 2101 via the Input/Output Interface 2110. Any operation and/or result of the methods can be output in any form to an output device. Such output can be any form of visual representation, including, but not limited to, textual, graphical, animation, audio, tactile, and the like. The display device 2111 and computing device 2101 can be part of one device, or separate devices.

The computing device 2101 can operate in a networked environment using logical connections to one or more remote computing devices 2114a,b,c and/or one or multiple storage server devices 2120. By way of example, a remote computing device can be a personal computer, portable computer, smartphone, a server, a router, a network computer, a peer device or other common network node, and so on. Logical connections between the computing device 2101 and a remote computing device 2114a,b,c and a server storage device of the server storage device(s) 2120 can be made via a network 2115, such as a local area network (LAN) and/or a general wide area network (WAN). Such network connections can be through the network adapter 2108. The network adapter 2108 can be implemented in both wired and wireless environments. In an aspect, one or more of the remote computing devices 2114a,b,c can comprise an external engine and/or an interface to the external engine.

For purposes of illustration, application programs and other executable program components such as the operating system 2105 are illustrated herein as discrete blocks, although it is recognized that such programs and components reside at various times in different storage components of the computing device 2101, and are executed by the one or more processors 2103 of the computer. An implementation of the software 2106 can be stored on or transmitted across some form of computer-readable media. Any of the disclosed methods can be performed by computer readable instructions embodied on computer-readable media. Computer-readable media can be any available media that can be accessed by a computer. By way of example and not meant to be limiting, computer-readable media can comprise “computer storage media” and “communications media.” “Computer storage media” comprise volatile and non-volatile, removable and non-removable media implemented in any methods or technology for storage of information such as computer-readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

It is to be understood that the computer-implemented methods and systems described here are not limited to specific operations, processes, components, or structure described, or to the order or particular combination of such operations or components as described. It is also to be understood that the terminology used herein is for the purpose of describing exemplary embodiments only and is not intended to be restrictive or limiting.

As used herein the singular forms “a,” “an,” and “the” include both singular and plural referents unless the context clearly dictates otherwise. Values expressed as approximations, by use of antecedents such as “about” or “approximately,” shall include reasonable variations from the referenced values. If such approximate values are included with ranges, not only are the endpoints considered approximations, the magnitude of the range shall also be considered an approximation. Lists are to be considered exemplary and not restricted or limited to the elements comprising the list or to the order in which the elements have been listed unless the context clearly dictates otherwise.

Throughout the specification and claims of this disclosure, the following words have the meaning that is set forth: “comprise” and variations of the word, such as “comprising” and “comprises,” mean including but not limited to, and are not intended to exclude, for example, other additives, components, integers, or operations. “Include” and variations of the word, such as “including” are not intended to mean something that is restricted or limited to what is indicated as being included, or to exclude what is not indicated. “May” means something that is permissive but not restrictive or limiting. “Optional” or “optionally” means something that may or may not be included without changing the result or what is being described. “Prefer” and variations of the word such as “preferred” or “preferably” mean something that is exemplary and more ideal, but not required. “Such as” means something that serves simply as an example.

Operations and components described herein as being used to perform the disclosed methods and construct the disclosed systems are illustrative unless the context clearly dictates otherwise. It is to be understood that when combinations, subsets, interactions, groups, etc. of these operations and components are disclosed, that while specific reference of each various individual and collective combinations and permutation of these may not be explicitly disclosed, each is specifically contemplated and described herein, for all methods and systems. This applies to all aspects of this application including, but not limited to, operations in disclosed methods and/or the components disclosed in the systems. Thus, if there are a variety of additional operations that can be performed or components that can be added, it is understood that each of these additional operations can be performed and components added with any specific embodiment or combination of embodiments of the disclosed systems and methods.

Embodiments of this disclosure may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices, whether internal, networked, or cloud-based.

Embodiments of this disclosure have been described with reference to diagrams, flowcharts, and other illustrations of computer-implemented methods, systems, apparatuses, and computer program products. Each block of the block diagrams and flowchart illustrations, and combinations of blocks in the block diagrams and flowchart illustrations, respectively, can be implemented by processor-accessible instructions. Such instructions can include, for example, computer program instructions (e.g., processor-readable and/or processor-executable instructions). The processor-accessible instructions can be built (e.g., linked and compiled) and retained in processor-executable form in one or multiple memory devices or one or many other processor-accessible non-transitory storage media. These computer program instructions (built or otherwise) may be loaded onto a general-purpose computer, special purpose computer, or other programmable data processing apparatus to produce a machine. The loaded computer program instructions can be accessed and executed by one or multiple processors or other types of processing circuitry. In response to execution, the loaded computer program instructions provide the functionality described in connection with flowchart blocks (individually or in a particular combination) or blocks in block diagrams (individually or in a particular combination). Thus, such instructions which execute on the computer or other programmable data processing apparatus create a means for implementing the functions specified in the flowchart blocks (individually or in a particular combination) or blocks in block diagrams (individually or in a particular combination).

These computer program instructions may also be stored in a computer-readable memory that can direct a computer or other programmable data processing apparatus to function in a particular manner, such that the instructions stored in the computer-readable memory produce an article of manufacture including processor-accessible instruction (e.g., processor-readable instructions and/or processor-executable instructions) to implement the function specified in the flowchart blocks (individually or in a particular combination) or blocks in block diagrams (individually or in a particular combination). The computer program instructions (built or otherwise) may also be loaded onto a computer or other programmable data processing apparatus to cause a series of operations to be performed on the computer or other programmable apparatus to produce a computer-implemented process. The series of operations can be performed in response to execution by one or more processor or other types of processing circuitry. Thus, such instructions that execute on the computer or other programmable apparatus provide operations for implementing the functions specified in the flowchart blocks (individually or in a particular combination) or blocks in block diagrams (individually or in a particular combination).

Accordingly, blocks of the block diagrams and flowchart illustrations support combinations of means for performing the specified functions in connection with such diagrams and/or flowchart illustrations, combinations of operations for performing the specified functions and program instruction means for performing the specified functions. Each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

The methods and systems can employ artificial intelligence techniques such as machine learning and iterative learning. Examples of such techniques include, but are not limited to, expert systems, case-based reasoning, Bayesian networks, behavior-based AI, neural networks, fuzzy systems, evolutionary computation (e.g. genetic algorithms), swarm intelligence (e.g. ant algorithms), and hybrid intelligent systems (e.g. expert inference rules generated through a neural network or production rules from statistical learning).

While the computer-implemented methods, apparatuses, devices, and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is in no way intended that an order be inferred, in any respect. This holds for any possible non-express basis for interpretation, including: matters of logic with respect to arrangement of operations or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
determining, by a computing device, based on a first interaction with a user interface, a selection of a first element of the user interface defining a data model, wherein the data model comprises a plurality of data tables;
determining, based on a second interaction with the user interface, a selection of a second element of the user interface defining a data context for the data model, wherein the second element is associated with one or more of: a dimension, a measure, or a filter associated with one or more data records within the plurality of data tables of the data model;
generating, based on the data model and the data context, the query, wherein the query is indicative of one or more of: the dimension, the measure, or the filter associated with the one or more data records; and
causing, based on the query, data responsive to the query to be output at the user interface.

2. The method of claim 1, wherein generating the query comprises generating a set expression based on the data model and the data context, wherein the set expression is associated with the data responsive to the query.

3. The method of claim 1, wherein the user interface comprises a configuration pane, and wherein determining the selection of the first element comprises:
receiving data indicative of a selection of a first selectable visual element within the configuration pane; and
causing presentation of an overlay element comprising one or more second selectable visual elements comprising the first element.

4. The method of claim 3, further comprising:
receiving data indicative of the selection of the first element; and
detecting a drag action that moves the first element from the configuration pane to a viewport pane of the user interface.

5. The method of claim 1, further comprising:
receiving data indicative of a selection of a defined selectable visual element within the user interface; and
causing presentation of a second user interface configured to edit a set expression associated with the data responsive to the query, wherein the second user interface comprises an edition pane that presents the query and is configured to receive input data defining one or more changes to the query.

6. The method of claim 1, wherein the first interaction and the second interaction each comprise drag-and-drop interactions with the user interface.

7. The method of claim 6, wherein the drag-and-drop interactions originate in a configuration pane of the user interface and terminate in a viewport pane of the user interface.

8. An apparatus, comprising:
one or more processors; and
memory storing processor-executable instructions that, when executed by the one or more processors, cause the apparatus to:
determine, based on a first interaction with a user interface, a selection of a first element of the user interface defining a data model, wherein the data model comprises a plurality of data tables;
determine, based on a second interaction with the user interface, a selection of a second element of the user interface defining a data context for the data model, wherein the second element is associated with one or more of: a dimension, a measure, or a filter associated with one or more data records within the plurality of data tables of the data model;
generate, based on the data model and the data context, the query, wherein the query is indicative of one or more of: the dimension, the measure, or the filter associated with the one or more data records; and
cause, based on the query, data responsive to the query to be output at the user interface.

9. The apparatus of claim 8, wherein the processor-executable instructions that cause the apparatus to generate the query further cause the apparatus to generate a set expression based on the data model and the data context, wherein the set expression is associated with the data responsive to the query.

10. The apparatus of claim 8, wherein the user interface comprises a configuration pane, and wherein the processor-executable instructions that cause the apparatus to determine the selection of the first element further cause the apparatus to:
receive data indicative of a selection of a first selectable visual element within the configuration pane; and
cause presentation of an overlay element comprising one or more second selectable visual elements comprising the first element.

11. The apparatus of claim 10, wherein the processor-executable instructions further cause the apparatus to:
receive data indicative of the selection of the first element; and
detect a drag action that moves the first element from the configuration pane to a viewport pane of the user interface.

12. The apparatus of claim 8, wherein the processor-executable instructions further cause the apparatus to:
receive data indicative of a selection of a defined selectable visual element within the user interface; and
cause presentation of a second user interface configured to edit a set expression associated with the data responsive to the query, wherein the second user interface comprises an edition pane that presents the query and is configured to receive input data defining one or more changes to the query.

13. The apparatus of claim 8, wherein the first interaction and the second interaction each comprise drag-and-drop interactions with the user interface.

14. The apparatus of claim 13, wherein the drag-and-drop interactions originate in a configuration pane of the user interface and terminate in a viewport pane of the user interface.

15. One or more non-transitory computer-readable media storing processor-executable instructions that, when executed by at least one processor, cause the at least one processor to:
determine, based on a first interaction with a user interface, a selection of a first element of the user interface defining a data model, wherein the data model comprises a plurality of data tables;
determine, based on a second interaction with the user interface, a selection of a second element of the user interface defining a data context for the data model, wherein the second element is associated with one or more of: a dimension, a measure, or a filter associated with one or more data records within the plurality of data tables of the data model;
generate, based on the data model and the data context, the query, wherein the query is indicative of one or more of: the dimension, the measure, or the filter associated with the one or more data records; and
cause, based on the query, data responsive to the query to be output at the user interface.

16. The one or more non-transitory computer-readable media of claim 15, wherein the processor-executable instructions that cause the at least one processor to generate the query further cause the at least one processor to generate a set expression based on the data model and the data context, wherein the set expression is associated with the data responsive to the query.

17. The one or more non-transitory computer-readable media of claim 15, wherein the user interface comprises a configuration pane, and wherein the processor-executable instructions that cause the at least one processor to determine the selection of the first element further cause the at least one processor to:
receive data indicative of a selection of a first selectable visual element within the configuration pane; and
cause presentation of an overlay element comprising one or more second selectable visual elements comprising the first element.

18. The one or more non-transitory computer-readable media of claim 17, wherein the processor-executable instructions further cause the at least one processor to:
receive data indicative of the selection of the first element; and
detect a drag action that moves the first element from the configuration pane to a viewport pane of the user interface.

19. The one or more non-transitory computer-readable media of claim 15, wherein the processor-executable instructions further cause the at least one processor to:
receive data indicative of a selection of a defined selectable visual element within the user interface; and
cause presentation of a second user interface configured to edit a set expression associated with the data responsive to the query, wherein the second user interface comprises an edition pane that presents the query and is configured to receive input data defining one or more changes to the query.

20. The one or more non-transitory computer-readable media of claim 15, wherein the first interaction and the second interaction each comprise drag-and-drop interactions with the user interface, and wherein the drag-and-drop interactions originate in a configuration pane of the user interface and terminate in a viewport pane of the user interface.
